(19) United States
(12) Patent Application Publication
(10) Pub. No.: US 2017/0269418 A1
(43) Pub. Date: Sep. 21, 2017

(54) Methods and Devices for Generation of Linearly Polarized Light

(71) Applicant: Mohammadhossein Shahali, Tehran (IR)

(72) Inventor: Mohammadhossein Shahali, Tehran (IR)

(21) Appl. No.: 15/450,800

(22) Filed: Mar. 6, 2017

Related U.S. Application Data
(60) Provisional application No. 62/309,014, filed on Mar. 16, 2016.

(51) Int. Cl. G02F 1/1335

(52) U.S. Cl. CPC G02F 1/13362; G02F 2203/01

(57) ABSTRACT

Methods and linear polarization devices for linear light polarization and display and illumination devices utilizing such methods and linear polarization devices are provided. The linear polarization devices generate linearly polarized light having a desirable axis of polarization from unpolarized light and include a first non-absorptive linear polarizing filter and one or more rotating filters and second linear polarizers. The first non-absorptive linear polarizing filter has a predetermined axis of polarization for decomposing incident light into a transmitted beam of light and a reflected beam of light wherein at least one of the transmitted beam of light and the reflected beam of light has an undesirable axis of polarization. The one or more rotating filters rotate the polarization axis/axes of the beam/beams of light having undesirable axis of polarization to the desirable axis of polarization. The second polarizers purify the beams of linearly polarized light from any unwanted polarization component just before they are transmitted.

### PRIORITY CLAIM

This application claims priority from U.S. Patent Application No. 62/309,014 filed on Mar. 16, 2016.

### TECHNICAL FIELD

The present invention generally relates to light polarization, and more particularly relates to methods and devices for generation of linearly polarized light for display backlighting and light sources.

### BACKGROUND OF THE DISCLOSURE

Spontaneous emission is the foundation of most light source operation including light sources such as florescent tubes, plasma display panels, light emitting diodes and incandescent bulbs. It is the process by which a quantum system such as an atom, molecule, nanocrystal or nucleus in an excited state undergoes a transition to a state with a lower energy and emits a quantum of energy in the form of photons. Even lasers start by spontaneous emission and then normal operation continues by stimulated emission.

The phase of a photon, the direction in which a photon propagates and the angle of the polarization axis of a photon in spontaneous emission are all random, in contrast to stimulated emission. As a result, almost all available light sources are only capable of emitting unpolarized, divergent, out-of-phase photons.

Linearly polarized light is beneficial as such light is provided in a direction (i.e., an angle) of the linear polarization. A conventional method of producing linearly polarized light typically includes two stages. At a first stage, a light source produces unpolarized light and then, in a second stage, the light passes through an absorptive linear polarizer, such as an absorptive linear polarizing film. A linear polarizer is an optical filter that lets light waves of a specific direction (angle) of linear polarization pass and blocks light waves of other directions of linear polarization partially or completely. The linear polarizer absorbs or reflects half of the incident unpolarized (randomly polarized) light in accordance with Malus' law of optics and what passes through the polarizer is linearly polarized light. Thus, in the conventional method of producing linearly polarized light at least half of the optical energy produced by the light source is converted into wasteful, unwanted heat energy.

Non-absorptive linear light polarizers include photorefractive linearly polarizing devices and wire grid polarizers. All photorefractive linearly polarizing devices are sensitive to the angle of incidence of light. Such linearly polarizing devices can cover a narrow range of the light spectrum because they rely on wavelength and refractive index (refractive incidence also being wavelength dependent). Wire polarizers can cover a very broad spectrum of light and their ranges of coverage are at least by average one order of magnitude broader than the photorefractive polarizing devices. Unlike photorefractive polarizing devices, wire grid polarizers are insensitive to the angle of incidence of light. Yet all of these devices suffer from the same weakness in that at least half of the optical energy received by the light polarizer is converted into wasteful, unwanted forms of energy such as heat.

Thus, what is needed is a linear polarization converter of light which overcomes the drawbacks of prior devices and efficiently and effectively polarizes received optical energy. Furthermore, other desirable features and characteristics will become apparent from the subsequent detailed description and the appended claims, taken in conjunction with the accompanying drawings and this background of the disclosure.

### SUMMARY

According to at least one embodiment of the present invention, a method for linear polarization of light is provided. The method includes generating optical energy of unpolarized light, transforming the unpolarized light into linearly polarized light, and transmitting at least some of the linearly polarized light as transmitted light, the transmitted light having a desirable axis of polarization. The transforming step includes decomposing the unpolarized light into a transmitted beam of light and a reflected beam of light, wherein at least one of the transmitted beam of light and the reflected beam of light has an undesirable axis of polarization. The transforming step also includes rotating a polarization axis of the light beam having the undesirable axis of polarization to the desirable axis of polarization for transmitting as at least some of the transmitted light.

According to at least an additional embodiment of the present invention, an illumination device for providing linearly polarized light having a desirable axis of polarization is provided. The illumination device includes a light source for generating unpolarized beams of light, a non-absorptive decomposing polarizing filter having a predetermined axis of polarization and one or more rotating filters. The non-absorptive decomposing polarizing filter decomposes the unpolarized beams of light incident thereon into a transmitted beam of light and a reflected beam of light, wherein at least one of the transmitted beam of light and the reflected beam of light has an undesirable axis of polarization. The one or more rotating filters rotate the polarization axis of the incident linearly polarized light beam having the undesirable axis of polarization to the desirable axis of polarization for transmitting as at least some of the provided linearly polarized light.

According to at least a further embodiment of the present invention, a display device is provided. The display device includes a transmissive display panel and a backlight for generating linearly polarized beams of light. The backlight acts as an illumination light source for the transmissive display panel and generates linearly polarized beams of light for utilization by the transmissive display panel to generate user viewable output thereon. The backlight includes a light source for generating unpolarized beams of light, a non-absorptive decomposing polarizing filter having a predetermined axis of polarization and one or more rotating filters. The non-absorptive decomposing polarizing filter decomposes the unpolarized beams of light incident thereon into a transmitted beam of light and a reflected beam of light, wherein at least one of the transmitted beam of light and the reflected beam of light has an undesirable axis of polarization. The one or more rotating filters rotate the polarization axis of the incident linearly polarized light beam having the undesirable axis of polarization to the desirable axis of polarization for transmitting as at least some of the generated linearly polarized beams of light. The transmissive display panel includes a first polarizing filter, a transmissive liquid crystal display panel and a second polarizing filter, wherein the polarization axis of the first polarizing filter of the transmissive display panel is parallel to the main polarization axis of the linearly polarized beams of light generated by the backlight.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 depicts a planar cross-sectional block diagram of a liquid crystal display (LCD) device in accordance with a present embodiment.

FIG. 2 depicts a Cartesian coordinate system depicting alignment of polarization vectors in accordance with the present embodiment.

FIG. 3 depicts a flowchart of a method for linear polarization of optical energy in accordance with the present embodiment.

FIG. 4 depicts an illustration of operation of the decomposition step of the flowchart of FIG. 3 in accordance with the present embodiment.

FIG. 5A depicts an illustration of operation of the recycle step of the flowchart of FIG. 3 in accordance with the present embodiment.

FIG. 5B depicts an illustration of operation of the recycle step of the flowchart of FIG. 3 in accordance with the present embodiment.

FIG. 6 depicts Cartesian coordinate systems illustrating the decomposition step of the flowchart of FIG. 3 in accordance with the present embodiment.

FIG. 7A depicts an illustration of operation of the rotation step of the flowchart of FIG. 3 in accordance with the present embodiment.

FIG. 7B depicts an illustration of operation of the rotation step of the flowchart of FIG. 3 in accordance with the present embodiment.

FIG. 8A depicts an illustration of optical energy of horizontal polarization during operation of the flowchart of FIG. 3 using a non-absorptive linear polarizing filter having a horizontal axis of polarization for the decomposition step in accordance with the present embodiment.

FIG. 8B depicts an illustration of optical energy of horizontal polarization during operation of the flowchart of FIG. 3 using a non-absorptive linear polarizing filter having a horizontal axis of polarization for the decomposition step in accordance with the present embodiment.

FIG. 9A depicts an illustration of optical energy of alpha degrees of polarization during operation of the flowchart of FIG. 3 using a non-absorptive linear polarizing filter having a horizontal axis of polarization for the decomposition step in accordance with the present embodiment.

FIG. 9B depicts an illustration of optical energy of alpha degrees of polarization during operation of the flowchart of FIG. 3 using a non-absorptive linear polarizing filter having a horizontal axis of polarization for the decomposition step in accordance with the present embodiment.

FIG. 10A depicts an illustration of optical energy of horizontal polarization during operation of the flowchart of FIG. 3 using a non-absorptive linear polarizing filter having a vertical axis of polarization for the decomposition step in accordance with the present embodiment.

FIG. 10B depicts an illustration of optical energy of horizontal polarization during operation of the flowchart of FIG. 3 using a non-absorptive linear polarizing filter having a vertical axis of polarization for the decomposition step in accordance with the present embodiment.

FIG. 11A depicts an illustration of optical energy of alpha degrees of polarization during operation of the flowchart of FIG. 3 using a non-absorptive linear polarizing filter having a vertical axis of polarization for the decomposition step in accordance with the present embodiment.

FIG. 11B depicts an illustration of optical energy of alpha degrees of polarization during operation of the flowchart of FIG. 3 using a non-absorptive linear polarizing filter having a vertical axis of polarization for the decomposition step in accordance with the present embodiment.

FIG. 12A depicts an illustration of a practical example of linear polarization converter devices in accordance with the present embodiment, where FIG. 12A depicts a device which uses a direction independent rotating filter for its operation.

FIG. 12B depicts an illustration of a practical example of linear polarization converter devices in accordance with the present embodiment, where FIG. 12B depicts a device which uses a direction independent rotating filter for its operation.

FIG. 12C depicts an illustration of a practical example of linear polarization converter devices in accordance with the present embodiment, where FIG. 12C depicts a device which uses direction dependent rotating filters for its operation.

FIG. 12D depicts an illustration of a practical example of linear polarization converter devices in accordance with the present embodiment, where FIG. 12D depicts a device which uses direction dependent rotating filters for its operation.

FIG. 13 depicts an illustration of another design of a practical example of linear polarization converter devices which uses one vertical non-absorptive linear polarizer and one horizontal non-absorptive linear polarizer for its operation in accordance with the present embodiment.

FIG. 14 depicts an illustration of another design of a practical example of linear polarization converter devices which uses two horizontal non-absorptive linear polarizers for its operation in accordance with the present embodiment.

FIG. 15A depicts an illustration of a practical example of linear polarization converter devices in accordance with the present embodiment, where FIG. 15A depicts another design of a device which uses a direction independent rotating filter for its operation.

FIG. 15B depicts an illustration of a practical example of linear polarization converter devices in accordance with the present embodiment, where FIG. 15B depicts another design of a device which uses direction dependent rotating filters for its operation.

FIG. 16A depicts an illustration of optical components for generating parallel light rays in accordance with the present embodiment, wherein FIG. 16A depicts an exemplary optical lens.

FIG. 16B depicts an illustration of optical components for generating parallel light rays in accordance with the present embodiment, wherein FIG. 16B depicts an exemplary concave mirror.

FIG. 17 depicts an illustration of avoiding unwanted optical effects of a boundary between air and a dielectric mirror in accordance with the present embodiment.

FIG. 18 depicts an illustration of a device using the optical components of FIG. 16A and the dielectric mirror of FIG. 17 as a non-absorptive linear polarizer in accordance with the present embodiment.

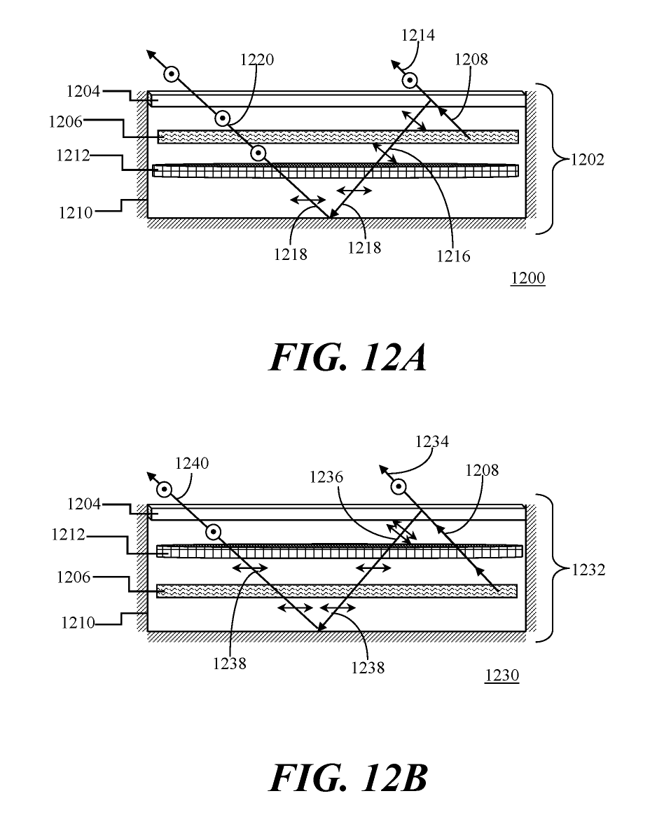

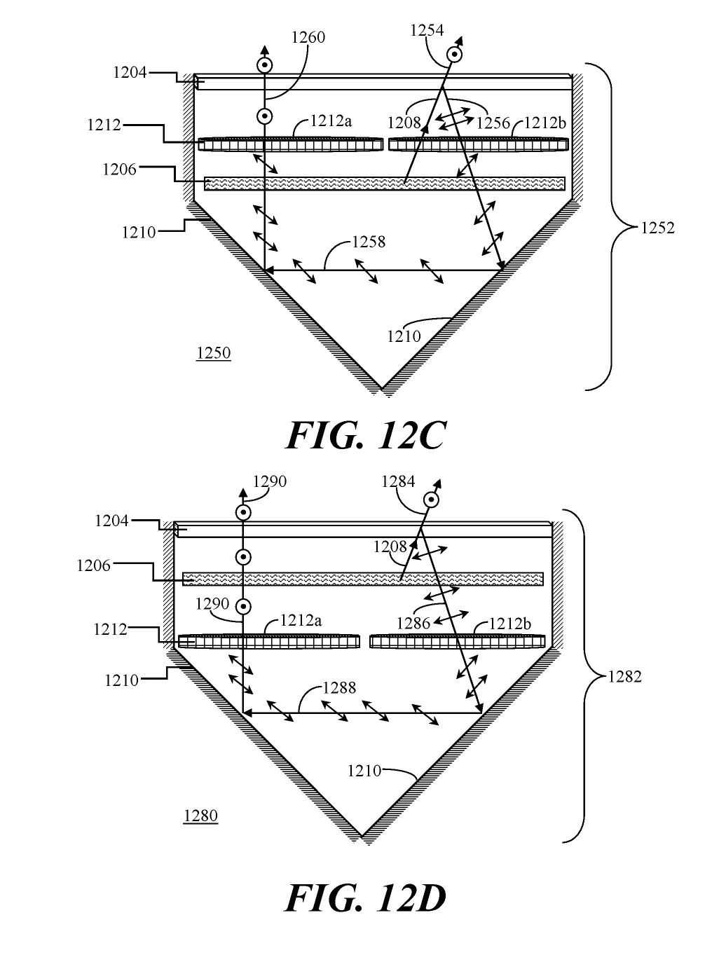

And FIG. 19 depicts an illustration of an exemplary device using the design of FIG. 12B in combination with a simplified LED technology in accordance with the present embodiment.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to present a linear polarization converter device having an energy efficient, scalable structure providing reduced cost of production as well as reduced power requirements for operation.

Among other applications, the novel linear polarization converter device in accordance with present embodiments can be used for robust backlighting of light emitting diode (LEDs) displays and liquid crystal displays (LCDs) and other transmissive display panels for providing linearly polarized backlight with a substantial reduction or even elimination of unwanted, wasteful heat energy in display devices such as big screen televisions, video projectors, computer displays and displays on tablets, cellphones, mp3/4 players and smart watches.

In addition, the innovative linear polarization converter devices in accordance with present embodiments can be incorporated into illumination devices to provide reduced cost of production and operation, operational energy savings, and reduced device size and weight. For illumination devices such as flash devices for cameras or cellphones, the inventive linear polarization converter device in accordance with present embodiments also provides significant reduction of back reflection of light from the surface of transparent materials such as water and glass and even back reflection of light from the surface of human skin and eyes providing a deep enhanced uniform illumination.

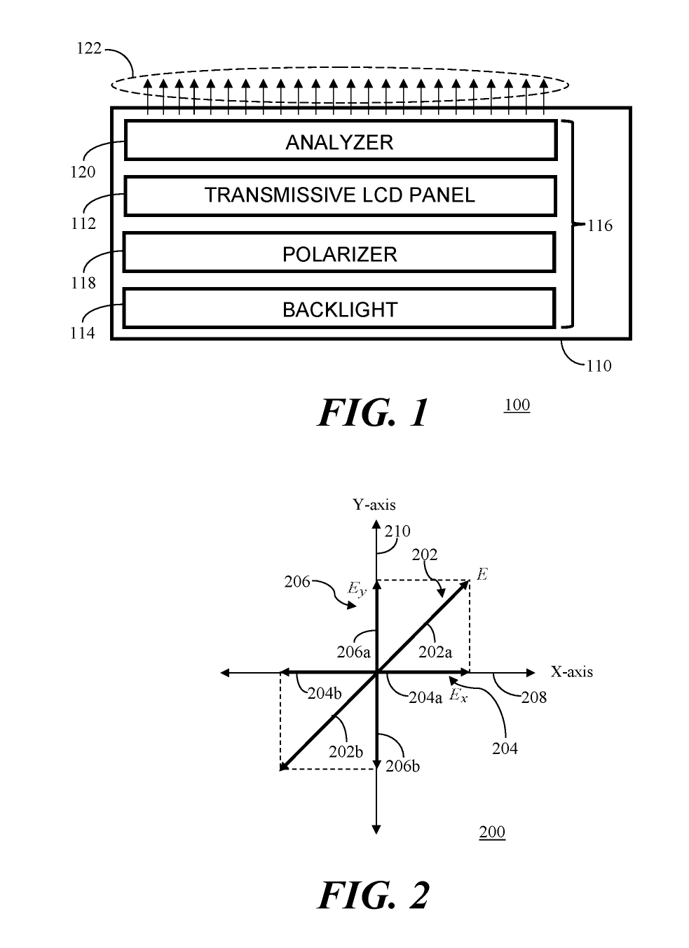

Referring to FIG. 1, a planar cross-sectional block diagram 100 of a liquid crystal (LC) display 110 in accordance with a present embodiment includes a transmissive LCD panel 112. Since LCD panels produce no light of their own, a backlight 114 is provided at the back of the LC display 110 “stack” 116 to illuminate the transmissive panel 112 and produce a visible image on the LC display 110. As linearly polarized light is required for proper illumination and viewing of the LCD panel 112, the LCD panel is sandwiched between a first light polarizer 118 for providing completely linearly polarized light for illumination and a second polarizer 120 (typically called an analyzer) which is used to carve out the unwanted part of the uniformly bright backlight to create the visible image 122 of different brightness and color in its different pixels. The degree of brightness of each sub pixel and brightness and color of each pixel of the visible image 122 is determined by the rotation angle of the uniformly polarized backlight as encoded by the LCD panel 112. Indeed, the analyzer 120 acts like a developer solution in chemical photography which develops a visible image for the observer. Those skilled in the art will realize that other elements (e.g., color filter) could be included for optimization of the function of the LC display 110.

The conventional backlight 114 and illumination devices like camera flashes and most of the light sources provide light by the means of spontaneous emission of photons. The phase of the photons, the direction in which the photons propagate and the angles of polarization of the photons in spontaneous emission are all random. As a result, the conventional backlight 114 and illumination devices, like almost all other light sources except lasers, are only capable of emitting unpolarized, divergent, out of phase photons. In a beam of unpolarized light, each individual photon has its own state of polarization as shown in FIG. 2. FIG. 2 depicts a Cartesian coordinate system 200 wherein a polarization axis vector 202 represents a direction or alignment of electric field oscillation (E) which consists of a positive portion 202a and a negative portion 202b. Each one of these vectors 202a, 202b could be decomposed or resolved into two mutually perpendicular vectors 204a, 206a and 204b, 206b, respectively, which are the projections of the original vectors on the horizontal x-axis 208 and vertical y-axis 210. The new vectors 204, 206 are the components of the E vector 202 on the x-axis 208 and the y-axis 210 which are hereinafter labeled E with subscripts named after the axis on which they are formed (e.g., Eₓ 204 and E_{y} 206).

Malus' law in optics states:

I=I₀×(cos θ)² (1)

where I=the intensity of transmitted light, I₀=the intensity of incident linearly (plane) polarized light, and θ=the angle between the polarization axis of incident linearly polarized light and the polarization axis of the linear polarizer. If the intensity of incident light is held constant, the value of θ angle is the key variable in Equation 1. And if θ=0, then (cos θ)²=1 and, as a result, in an ideal linear polarizer, if the polarization axis of an incident linearly polarized beam of light is parallel to the polarization axis of the linear polarizer, then all of the incident photons of light will be transmitted through the polarizer without absorption or reflection and the efficiency of light transmission through such polarizer is 100% and no light attenuation will occur due to the polarization state of the incident light beam.

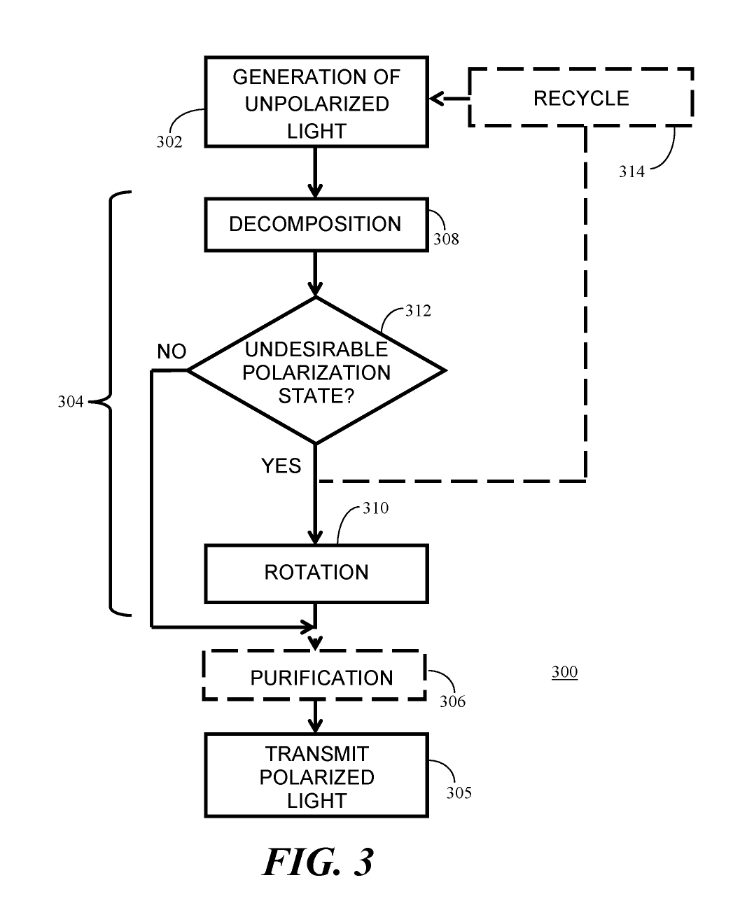

In accordance with a present embodiment, an innovative robust linear polarization converter device could present near ideal efficiency. Referring to FIG. 3, a flowchart 300 depicts a method for linear polarization in accordance with the present embodiment. The method comprises three stages: generation 302, transformation 304, and purification 306 (the purification 306 stage is optional as indicated by the dotted line). In the first stage 302, any suitable source of light is used to generate a natural or unpolarized beam of light. In the second stage 304, the light is linearly polarized as much as possible. This second stage 304 creates the efficiency gap between the method in accordance with the present embodiment and conventional methods for generating linearly polarized light which is transmitted 305.

The second stage 304 comprises two steps: decomposition 308 and rotation 310. At the decomposition stage 310, the light is divided into transmitted light and reflected light by a non-absorptive linearly polarizing filter. Optical elements known as non-absorptive linearly polarizing filters include a range of devices which are capable of dividing an incident beam of unpolarized light into two beams of linearly polarized light. Ideally, such non-absorptive linearly polarizing filters divide the incident beam into the two beams of linearly polarized light without a significant absorption of light. The polarization could be partial or complete and each of various non-absorptive linearly polarizing filters uses their own set of distinct principals of operation (e.g., birefringence, total internal reflection, Fresnel equation, or electrical conductivity (plasmon)). Wire grid polarizers and distributed Bragg reflectors (dielectric mirrors) at their Brewster's angle of incidence are examples of such filters.

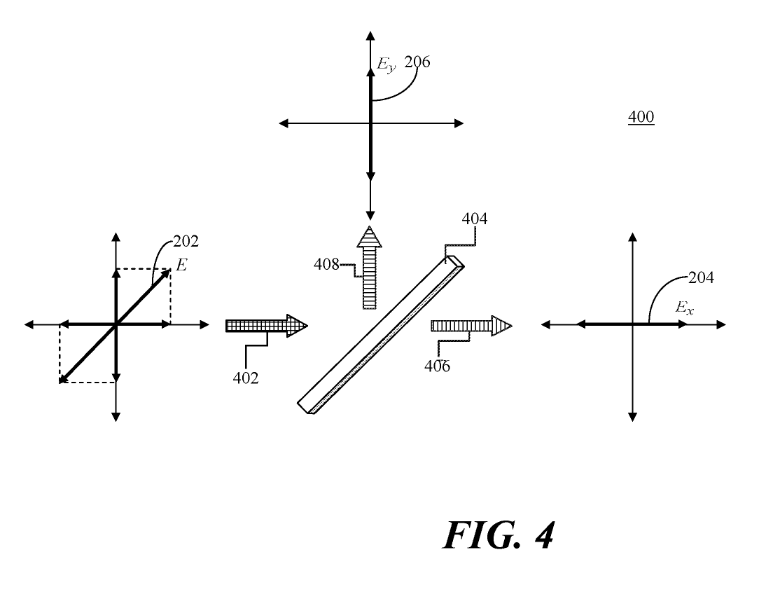

Referring to FIG. 4, an illustration 400 depicts the decomposition step 308 where an incident beam of light 402 is divided into two distinct beams by a non-absorptive ideal linear polarizer 404. The two distinct beams include a transmitted beam of light 406 and a reflected beam of light 408. The axis of polarization of the linear polarizer 404 is horizontal (i.e., parallel to the x-axis of the Cartesian coordinate system), and the photons in the transmitted beam of light 406 are those that have a polarization axis parallel to the polarization axis of the linear polarizer 404.

The state of polarization of each light beam is schematically depicted in the Cartesian coordinate system depicted adjacent to it. As the polarization axis of the non-absorptive linear polarizer 404 is parallel to the x-axis of Cartesian coordinate system and the E vector 202 schematically represents the polarization state of a sample random individual photon in the incident beam of unpolarized light 402, then the Eₓ vector 204 (i.e., the horizontal component of the E vector) shows the polarization state of photons transmitted through the non-absorptive ideal linear polarizer 404. The reflected or rejected beam of light 408 bounces off the non-absorptive ideal linear polarizer 404 and the E_{y} vector 206 (i.e., the vertical component of the E vector 202) shows the polarization state of photons in the reflected beam of light 408. These photons in the reflected beam of light 408 are the remainders of the photons in the incident beam 402 in terms of their energy and in terms of mathematical resolution of their individual polarization state vectors as determined by Malus' law, mathematical resolution of vectors and the law of conservation of energy. Those skilled in the art will realize that an ideal non-absorptive linear polarizer 404 will divide an incident unpolarized beam of light 402 into two beams of linearly polarized light 406, 408 having mutually perpendicular axes of polarization 204, 206.

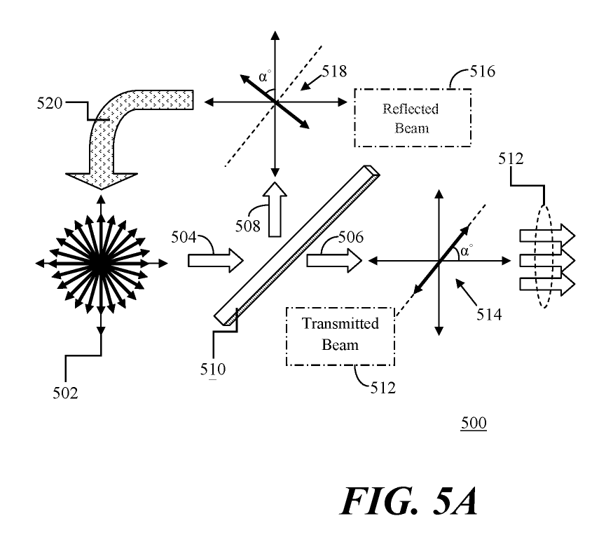

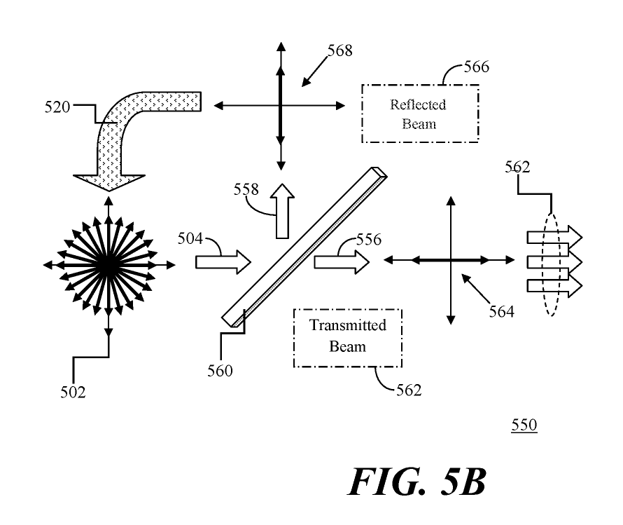

In accordance with one aspect of the present embodiment, when only one of the two beams of linearly polarized light 406, 408 has the desirable polarization state (step 312, FIG. 3), the undesirable beam could be recycled 314 to generate a new generation of unpolarized photons as depicted in FIGS. 5A and 5B. FIGS. 5A and 5B, illustrations 500, 550 depict recycling step in accordance with the present embodiment. In these two figures we assume that the desirable polarization axis is parallel to the polarization axis of the non-absorptive linear polarizer, thus the transmitted beam of light has the desirable state of polarization. A light source 502 produces randomly polarized (unpolarized) light. Referring to FIG. 5A, photons 504 of the unpolarized light are divided into two beams of photons 506, 508 by a non-absorptive polarizing filter 510 having an axis of polarization at an angle of α° to the x-axis. Thus, the transmitted beam of photons 506 forms a linearly polarized light beam 512 having an axis of linear polarization of α° to the x-axis as shown in the Cartesian coordinate system 514.

The reflected photons 508 form a reflected beam of light 516 which do not have the desirable axis of linear polarization as shown in the Cartesian coordinate system 518. These photons 508 are recycled 520 by reflecting the light beam 516 back to the light source 502 for absorption and generation of a new population of photons.

Referring to FIG. 5B, the photons 504 of the unpolarized light are divided into two beams of photons 556, 558 by a non-absorptive polarizing filter 560 which has an axis of polarization parallel to the x-axis. Thus, the transmitted beam of photons 556 forms a linearly polarized light beam 562 having an axis of linear polarization parallel to the x-axis as shown in the Cartesian coordinate system 564.

The reflected photons 558 form a reflected beam of light 566 which do not have the desirable axis of linear polarization as shown in the Cartesian coordinate system 568. These photons 558 are recycled 520 by reflecting the light beam 566 back to the light source 502 for absorption and generation of a new population of photons.

Recycling 520 is an optional step 314 as shown by the dotted box and arrows in FIG. 3. If recycling is not an option due to low efficiency of the unpolarized light source 502 or any other cause, processing of the two beams of linearly polarized light occurs as hereinafter described.

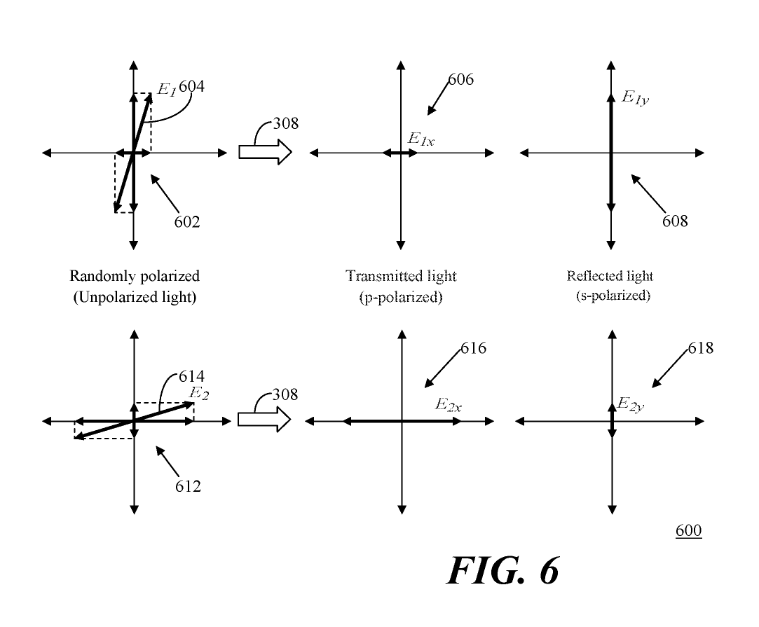

Referring to FIG. 6, an illustration 600 shows the first step of the second stage 304, the decomposition step 308 for two exemplary photons. a Cartesian coordinate system 602 depicting a first photon in the incident beam of light having a first energy vector E₁ 604 and two Cartesian coordinate systems 606, 608 depicting the decomposed photon E₁ₓ, E_{1y} after the decomposition step 308. Similarly, show a Cartesian coordinate system 612 depicting a second photon in the incident beam of light having a second energy vector E₂ 614 and two Cartesian coordinate systems 616, 618 depicting the decomposed photon E₂ₓ, E_{2y} after the decomposition step 308.

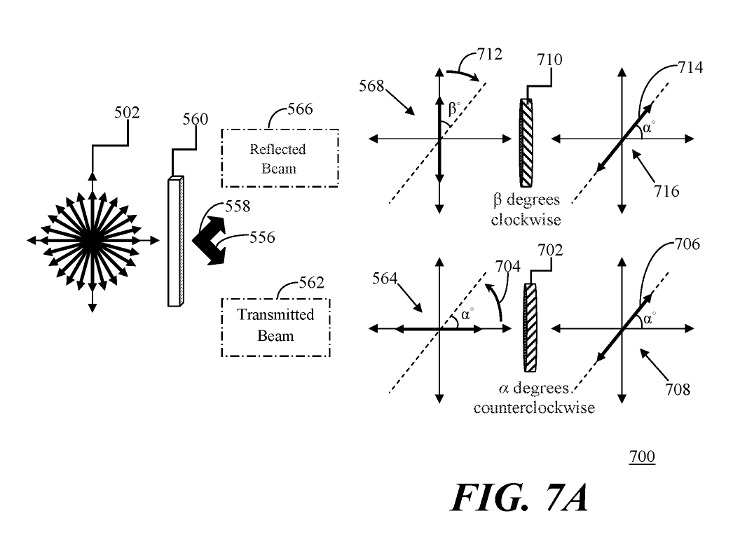

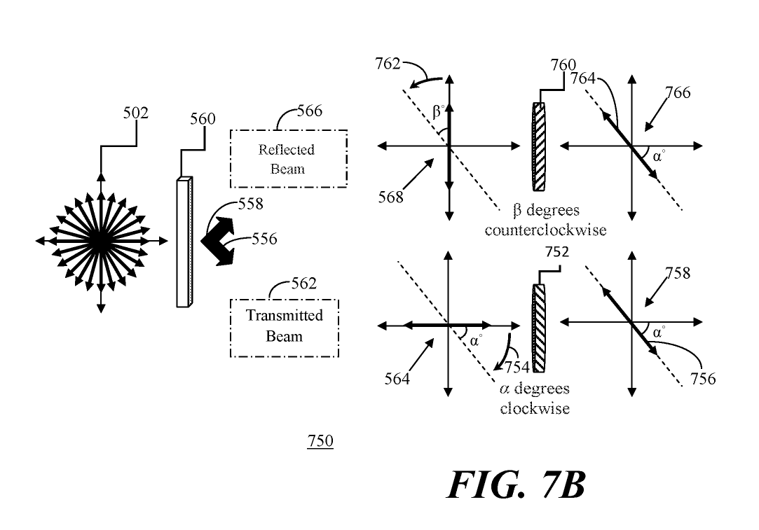

In accordance with the present embodiment, the second step of the second stage 304 is the rotation step 310 so named because it can makes use of a physical phenomenon known as optical rotation to rotates the polarization axis of a undesirably linearly polarized beam of light to a desirable axis of polarization. Referring to FIGS. 7A and 7B, illustrations 700, 750 depict the process of the rotation step 310 in accordance with the present embodiment. In accordance with the present embodiment, the incident linearly polarized beam of light 562 passes through an optically active material 702 which rotates the axis or plane of polarization of the incident beam of light 562 uniformly by a predetermined angle of α°. The rotation could be clockwise 754 by a degrees or counterclockwise 704 by α degrees, and the optically active material is termed a dextrorotary material 752 or a levorotary material 702 depending upon the direction of rotation induced in the polarization axis of the linearly polarized incident light. Ideally, if the monochrome incident beam of light 562 is completely linearly polarized, then the beam of light exiting the material 702, 752 will be completely polarized too, but in a different angle or plane of linear polarization 706, 756 as shown in the Cartesian coordinate systems 708, 758. The amount of rotation by the material 702, 752 depends on the optical path length, and the specific rotational properties of the material 702, 752 as well as on the wavelength of the incident light 562 and the temperature. The specific rotation of the material 702, 752 is influenced by internal structural parameters of the material 702, 752 including concentration of a solution, chemical spatial structure, state of isomerism, and degree of crystallization. If the conditions of the material 702, 752 and the light 562 incident on the material 702, 752 remain unchanged, the amount of rotation and the direction of rotation remain constant.

By means of utilizing optical rotation or polarization axis rotation of any suitable kind of technology, the optical filters 702, 752 are made for the transmitted linearly polarized beams 562 to uniformly rotate the polarization axis of the linearly polarized beam of light 562 by the desired angle of α and in the desired direction under given conditions without changing its state of linear polarization. These filters 702, 752, are termed rotating filters and are treated as optical elements with the angle and direction of rotation 704, 754 depicted schematically in FIGS. 7A and 7B and for the following figures, using their respective numerals. These optical filters (rotating filters) could be a single solid piece or a set of filters to produce the desired rotational effect on the light transmitted through it/them.

In a similar manner, the incident linearly polarized reflected beam of light 566 passes through an optically active material termed a rotating filter 710, 760 which rotates the axis or plane of polarization of the reflected beam of light 566 uniformly by a predetermined angle of β° in a clockwise direction 712 or a counterclockwise direction 762. Ideally, if the monochrome incident beam of light 566 is completely polarized, then a beam of light exiting the filter 710, 760 will be completely polarized too, but in a different angle or plane of linear polarization 714, 764 as shown in the Cartesian coordinate systems 716, 766. As a and 13 are complementary angles (|α|+|β|=90°), the resulting angle of the polarization axes of the beams of light exiting 706, 714 the rotating filters 710, 702 are in an a degrees counterclockwise linear polarization to the x-axis. In the same manner, the resulting angle of polarization axes of the beams of light 756, 764 exiting the rotating filters 752, 760 are in an a degrees clockwise linear polarization to the x-axis as depicted in the illustrations 700, 750. The reason for this pattern of rotation will be further explained herein. As seen from FIGS. 7A and 7B, the straight dashed lines in the Cartesian coordinate systems 564, 568, 708, 716 (FIG. 7A) and in the Cartesian coordinate systems 564, 568, 758, 766 (FIG. 7B) represent the desirable direction of the polarization axis which becomes parallel with the direction of the polarization state vectors (axes) 706, 714, 756, 764 of the exiting beams of light which are at an a degrees to the x-axis of the Cartesian coordinate systems 708, 716, 758, 766 (an a degrees counterclockwise angle to the x-axis of the Cartesian coordinate systems 708, 716 and an a degrees clockwise angle to the x-axis of the Cartesian coordinate systems 758, 766).

The non-absorptive linear polarizer 560 in the exemplary polarization systems in accordance with the present embodiment depicted in FIG. 7B divides the incident beam of unpolarized light from the light source 502 into two beams of linearly polarized light 562, 566 having their axes of polarization differ by a 90° angle (i.e., the axes are perpendicular to each other). In order to produce a uniformly polarized beam of light in accordance with the present embodiment, the two axes of polarization of the two polarized beams must rotate into two mutually opposite directions (one clockwise and the other counterclockwise) to make the axes of polarization rotate towards each other, or away from each other by the net sum of 90 degrees. Referring to FIGS. 7A and 7B, the illustrations 700, 750 depict the two possible states of rotation where α and β are complementary angles (i.e., |α|+|β|=90°). The α angle represents the rotation of the polarization axis of the transmitted beam of light 562 and the β angle represents the rotation of the polarization axis of the reflected beam of light 566. The complementary angles of α and β optimizes the efficiency of the device operationally where the rotating filters 710, 760 rotate the polarization axes of the reflected beams 566 opposite to, but complementary to the rotation of the transmitted beams 562 by the rotating filters 702, 752. Note that a range of angles α and β where |α|+|β|≠90° is possible in accordance with the present embodiment if the device is operative and the operation is rational. While the present embodiment encompasses rotating filter structures where the polarization axes of both beams are rotated, those skilled in the art will realize that structure and operation in accordance with the present embodiment also encompasses devices or systems where the polarization axis of one beam is fixed and the polarization axis of the other beam is rotated.

Rotating filters are optical filters used to rotate the polarization axis of incident linearly polarized light by a desired angle in a desired direction by means of using any suitable technology. There are a number of technologies suitable for rotating the plane or the axis of polarization of the incident linearly polarized beam of light by a predetermined amount. Any of these technologies is acceptable for use as rotating filters in accordance with the present embodiment so long as they do not change the state of polarization of the incident light from linear polarization to circular or elliptical polarization. For example, when this rotation takes place in the presence of an external magnetic field parallel to the direction of propagation of the incident beam of light through the medium of the rotating filter, it is the Faraday Effect and the device is known as a Faraday rotator. As another example, half-wave length polarization rotators use a different and distinct set of principles of operation but could also be used as the rotating filters in accordance with the present embodiment. The only exception for half wave length plates to be used as rotating filters is where photorefractive polarizing devices have been used as the non-absorptive linear polarizer at the decomposition stage. This exception is merely due to a grammatical reason, not a scientific reason. A direction dependent rotating filter is a type of filter which could cancel out its own rotational effect on the polarization axis of the incident beam of light if the beam optically travels for a second time on the same path through the same filter but in the opposite direction. Indeed, the net rotational effect could become zero after such a second pass wherein zero rotation is undesirable. It is important for the direction dependent rotating filters to configure the decomposing non-absorptive polarizing filter, the reflective surfaces and the one or more direction dependent rotating filters in a manner to avoid the rays of light passing optically twice through the same rotating filter of direction dependent type in two mutually opposite directions after the decomposition of rays of light. On the other hand, a direction independent rotating filter is a type of filter which increasingly rotates the polarization axis of the incident linearly polarized beam of light if the beam optically travels for a second time on the same path through the same filter but in the opposite direction.

The third and final step of the method in accordance with the present embodiment is the purification step 306 (FIG. 3). This step is optional as indicated by the dotted box for step 306 in FIG. 3. Since any type of non-absorptive linearly polarizing filter can be used as a polarizing filter at the decomposition step (i.e. the polarizing filter 560 in FIGS. 7A, 7B), the degree of polarization of the output beam may vary widely. Absorptive linearly polarizing filters are commercially available today with a near perfect capability to polarize the incident light and, by using such precision absorptive polarizers, the two beams of linearly polarized light 706, 714, 756, 764 produced after the rotating step 310 could be purified from any unwanted polarization components. Any type of precision (near ideal) linear polarizer is acceptable to be used for the purification step but the absorptive linear polarizers are the least expensive for such use. Such filters completely correct the polarization state of all the incident photons by completely blocking the undesirable components of their polarization state vectors. The most important part of the purification step 306 is to align the axis of polarization of the linearly polarizing filter with the main polarization axis of the incident linearly polarized beam of light in order to minimize the amount of optical loss and optimize the efficiency of filtration.

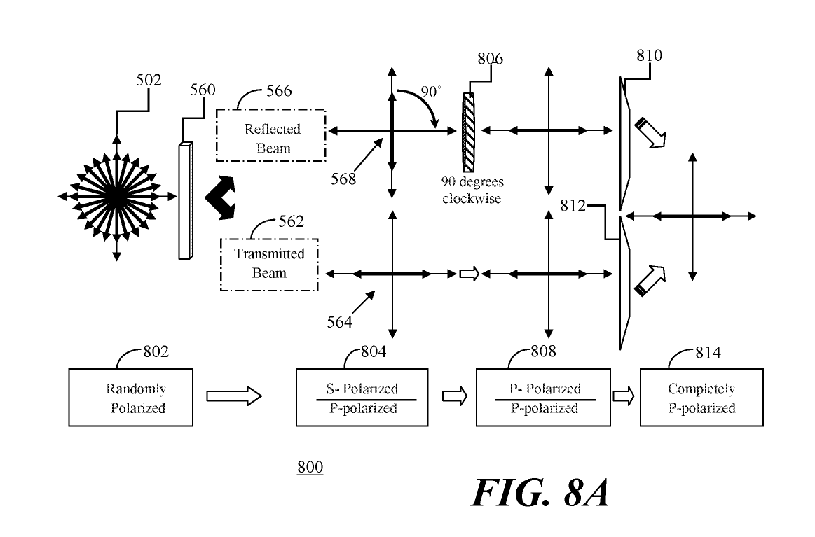

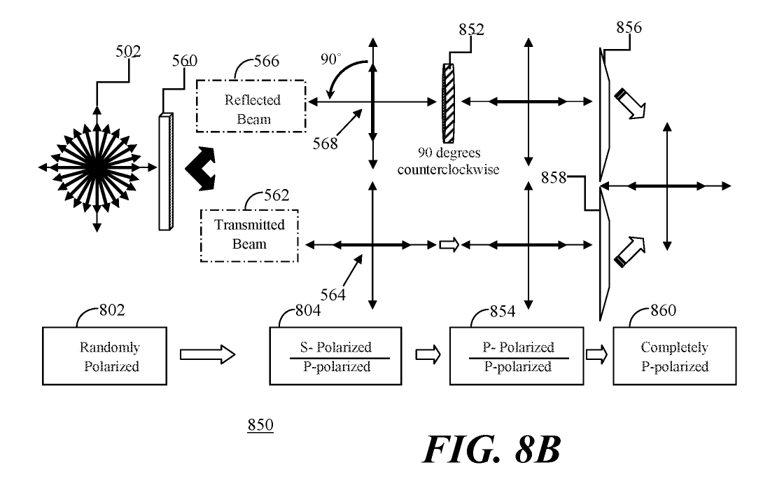

Referring to FIGS. 8A to 11B, theoretical principles of devices in accordance with present embodiments are illustrated in diagrams which show the state of polarization of each beam of light at each stage of the process depicted in the flowchart 300 (FIG. 3) and each diagram includes a set of four boxes elucidating the sequence of the events. Any optical element depicted in FIGS. 8A to 11B could be either a single solid piece optical element or a set of optical elements which could produce the desired effect. Any device that follows the theoretical principles of operation in accordance with the present embodiments disclosed and claimed herein falls under at least one or more of the eight distinct processes illustrated in FIGS. 8A to 11B.

Referring to FIGS. 8A and 8B, illustrations 800, 850 depict operation in accordance with the present embodiment where the desirable polarization axis is parallel to the x-axis and the transmitted beam 562 from the linear polarizing filter 560 is in the desirable direction (parallel to the x-axis). In the illustration 800, randomly polarized light is emitted 802 from the light source 502. The non-absorptive polarizing filter 560 having a horizontal axis of polarization (parallel to the x-axis) divides the randomly polarized light into a transmitted beam 562 and a reflected beam 566 which are polarized 804 horizontally (as shown in the Cartesian coordinate system 564) and vertically (as shown in the Cartesian coordinate system 568), respectively.

As horizontal is the desirable axis of polarization, no rotating of the transmitted beam 562 is required. The reflected beam 566, on the other hand, passes through a rotating filter 806 which rotates the polarization axis of the light beam 566 ninety degrees clockwise such that both light beams are polarized 808 horizontally (P-Polarized). A first absorptive polarizing filter 810 having its axis of polarization parallel to the x-axis (horizontal) and a second absorptive polarizing filter 812 having a horizontal axis of polarization are used to purify the two beams and create a single state of linear polarization in both completely polarized beams 814.

The illustration 850 differs from the illustration 800 in that the reflected light beam 566 having a vertical axis of polarization passes through a rotating filter 852 which rotates the polarization axis of the reflected light beam 566 ninety degrees counterclockwise such that both light beams are polarized 854 horizontally (P-Polarized). A first absorptive polarizing filter 856 having its axis of polarization parallel to the x-axis (horizontal) and a second absorptive polarizing filter 858 having a horizontal axis of polarization are used to purify the two beams and create a single state of linear polarization in both completely polarized beams 860 in a similar manner to that of the illustration 800.

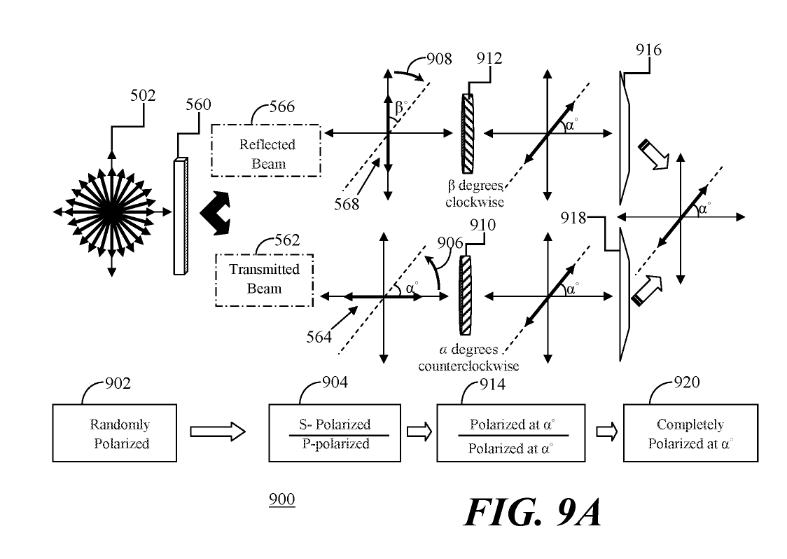

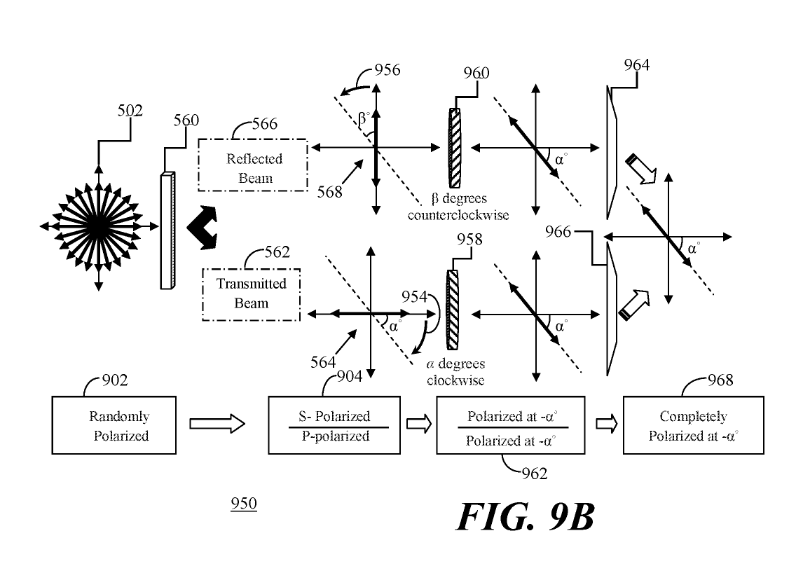

Referring to FIGS. 9A and 9B, illustrations 900, 950 depict operation in accordance with the present embodiment where the desirable polarization axis is at ±α degrees to the x-axis and the reflected beam 566 and the transmitted beam 562 from the linear polarizing filter 560 are not in the desirable direction of linear polarization. In FIGS. 9A and 9B, illustrations 900,950, the desirable polarization axis is at α degrees counterclockwise to the x-axis and α degrees clockwise to the x-axis respectively. In the illustration 900, randomly polarized light is emitted 902 from the light source 502. The non-absorptive polarizing filter 560 having a horizontal axis of polarization (i.e., parallel to the x-axis) divides the randomly polarized light into a transmitted beam 562 and a reflected beam 566 which are polarized 904 horizontally (as shown in the Cartesian coordinate system 564) and vertically (as shown in the Cartesian coordinate system 568), respectively. The straight dashed lines in the Cartesian coordinate systems 564, 568 represent the desirable direction of the polarization state vector (α degrees counterclockwise to the x-axis) of the resultant beam of light. Thus, the polarization axis of the transmitted beam 562 needs to be rotated α degrees counterclockwise 906 and polarization axis of the reflected beam 566 needs to be rotated β degrees clockwise 908 where α and β are complementary angles (|α|+|β|=90°).

The transmitted beam 562 passes through a rotating filter 910 which rotates the polarization axis of the light beam 562 α degrees counterclockwise 906 and the reflected beam 566 passes through a rotating filter 912 which rotates the polarization axis of the light beam 566 β degrees clockwise 908 such that both light beams are polarized 914 at α° counterclockwise to the x-axis. A first absorptive polarizing filter 916 having its axis of polarization at α degrees counterclockwise to the x-axis and a second absorptive polarizing filter 918 having its axis of polarization at α degrees counterclockwise to the x-axis are used to purify the two beams and create a single state of linear polarization in both completely polarized beams 920.

The illustration 950 differs from the illustration 900 in that the desirable direction of the polarization axis of the resultant light beam is at α degrees clockwise to the x-axis as shown by the straight dashed lines in the Cartesian coordinate systems 564, 568. Thus, the polarization axis of the transmitted beam 562 needs to be rotated α degrees clockwise 954 and the polarization axis of the reflected beam 566 needs to be rotated β degrees counterclockwise 956.

The transmitted beam 562 passes through a rotating filter 958 which rotates the polarization axis of the light beam 562 α degrees clockwise 954 and the reflected beam 566 passes through a rotating filter 960 which rotates the polarization axis of the light beam 566 β degrees counterclockwise 956 such that both light beams are polarized 962 at α degrees clockwise to the x-axis. A first absorptive polarizing filter 964 having its axis of polarization at α degrees clockwise to the x-axis and a second absorptive polarizing filter 966 having its axis of polarization at α degrees clockwise to the x-axis are used to purify the two beams and create a single state of linear polarization in both completely polarized beams 968.

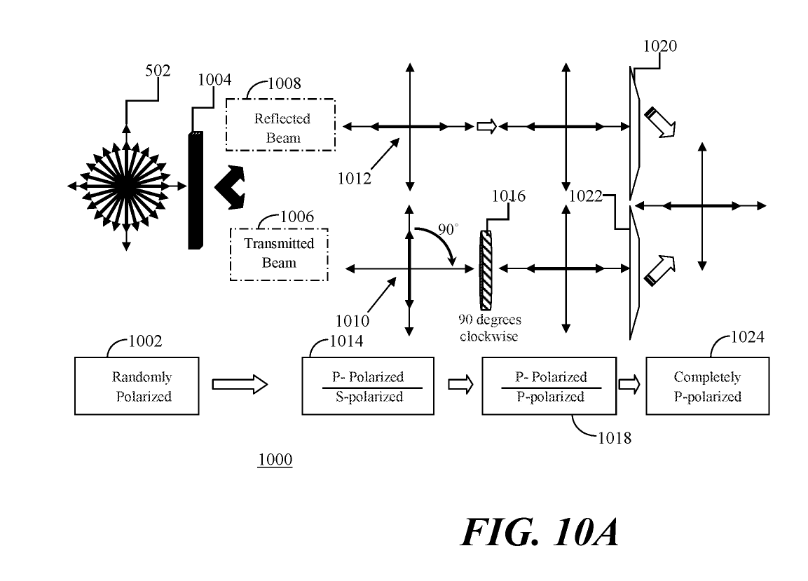

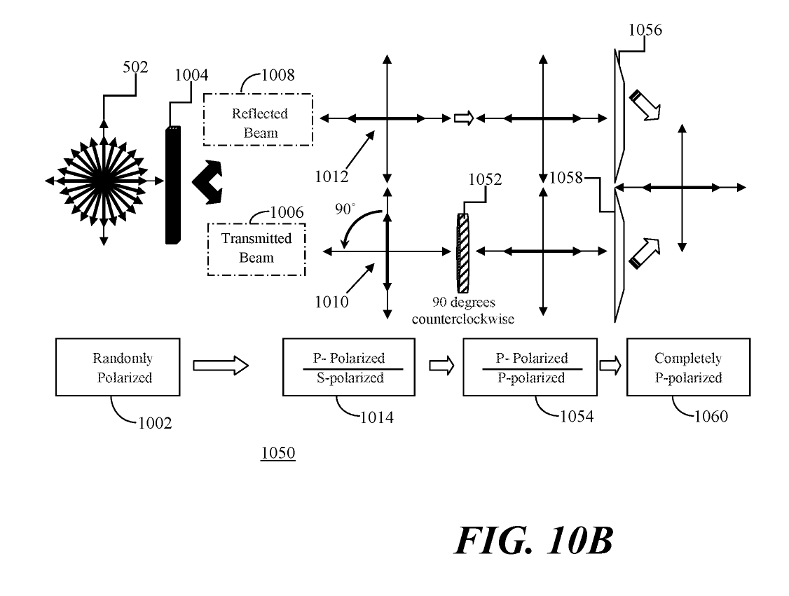

Referring to FIGS. 10A and 10B, illustrations 1000, 1050 depict operation in accordance with the present embodiment where the desirable polarization axis is parallel to the x-axis. In the illustration 1000, randomly polarized light is emitted 1002 from the light source 502. A non-absorptive polarizing filter 1004 having a vertical axis of polarization (parallel to the y-axis) divides the randomly polarized light into a transmitted beam 1006 and a reflected beam 1008 which are polarized 1014 vertically (as shown in the Cartesian coordinate system 1010) and horizontally (as shown in the Cartesian coordinate system 1012), respectively.

As horizontal is the desirable axis of polarization, no rotating of the reflected beam 1008 is required. The transmitted beam 1006, on the other hand, passes through a rotating filter 1016 which rotates polarization axis of the transmitted light beam 1006 ninety degrees clockwise such that both light beams are polarized horizontally 1018 (P-polarized). A first absorptive polarizing filter 1020 having its axis of polarization parallel to the x-axis (horizontal) and a second absorptive polarizing filter 1022 having a horizontal axis of polarization are used to purify the two beams and create a single state of linear polarization in both completely polarized beams 1024 having its axis of polarization horizontal (P-polarized).

The illustration 1050 differs from the illustration 1000 in that the transmitted light beam 1006 having a vertical axis of polarization passes through a rotating filter 1052 which rotates the polarization axis of the light beam 1006 ninety degrees counterclockwise such that both light beams are polarized horizontally 1054 (P-polarized). A first absorptive polarizing filter 1056 having its axis of polarization parallel to the x-axis (horizontal) and a second absorptive polarizing filter 1058 having a horizontal axis of polarization are used to purify the two beams and create a single state of linear polarization in both completely polarized beams 1060 having its axis of polarization horizontal (P-polarized) in a similar manner to that of the illustration 1000.

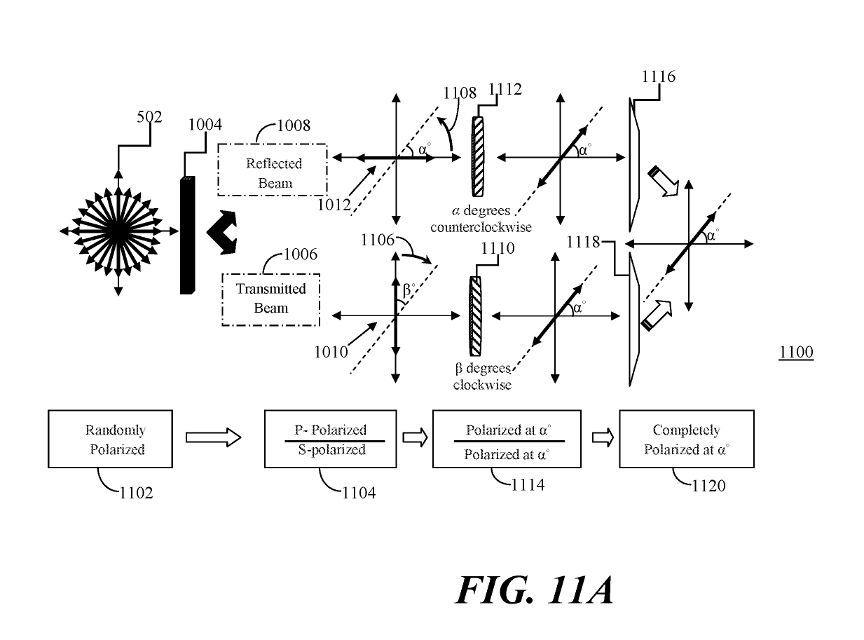

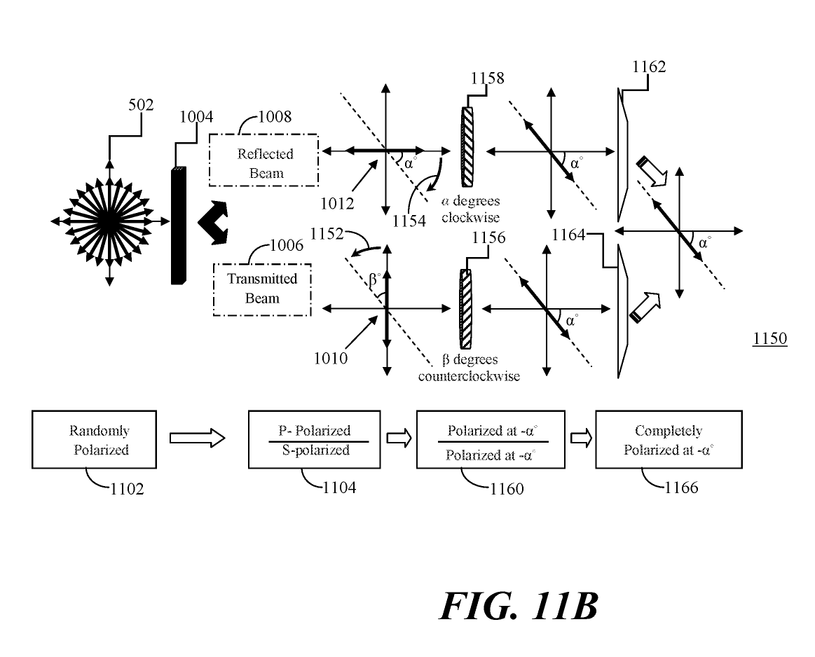

Referring to FIGS. 11A and 11B, illustrations 1100, 1150 depict operation in accordance with the present embodiment where the desirable polarization axis is at ±α degrees to the x-axis and the transmitted beam 1006 and the reflected beam 1008 are not in the desirable direction of linear polarization. In FIGS. 11A and 11B, illustrations 1100, 1150, the desirable polarization axis is at α degrees counterclockwise to the x-axis and α degrees clockwise to the x-axis, respectively. In the illustration 1100, randomly polarized light is emitted 1102 from the light source 502. The non-absorptive polarizing filter 1004 having a vertical axis of polarization (parallel to the y-axis) divides the randomly polarized light into the transmitted beam 1006 and the reflected beam 1008 which are polarized 1104 vertically (as shown in the Cartesian coordinate system 1010) and horizontally (as shown in the Cartesian coordinate system 1012), respectively. The straight dashed lines in the Cartesian coordinate systems 1010, 1012 represent the desirable direction of the polarization state vector (α degrees counterclockwise to the x-axis) of the resultant beam of light. Thus, the polarization axis of the transmitted beam 1006 needs to be rotated β degrees clockwise 1106 and the polarization axis of the reflected beam 1008 needs to be rotated α degrees counterclockwise 1108 where a and 13 are complementary angles (|α|+|β|=90°).

The transmitted beam 1006 passes through a rotating filter 1110 which rotates the polarization axis of the light beam 1006 β degrees clockwise 1106 and the reflected beam 1008 passes through a rotating filter 1112 which rotates the polarization axis of the light beam 1008 α degrees counterclockwise 1108 such that both light beams are polarized 1114 at α degrees counterclockwise to the x-axis. A first absorptive polarizing filter 1116 having its axis of polarization at α degrees counterclockwise to the x-axis and a second absorptive polarizing filter 1118 having its axis of polarization at α degrees counterclockwise to the x-axis are used to purify the two beams and create a single state of linear polarization in both completely polarized beams 1120.

The illustration 1150 differs from the illustration 1100 in that the desirable direction of the polarization axis of the resultant light beam is at α degrees clockwise to the x-axis as shown by the straight dashed lines in the Cartesian coordinate systems 1010, 1012. Thus, the polarization axis of the transmitted beam 1006 needs to be rotated β degrees counterclockwise 1152 and the polarization axis of the reflected beam 1008 needs to be rotated α degrees clockwise 1154.

The transmitted beam 1006 passes through a rotating filter 1156 which rotates the polarization axis of the light beam 1006 β degrees counterclockwise 1152 and the reflected beam 1008 passes through a rotating filter 1158 which rotates the polarization axis of the light beam 1008 α degrees clockwise 1154 such that both light beams are polarized at α degrees clockwise to the x-axis. A first absorptive polarizing filter 1162 having its axis of polarization at α degrees clockwise to the x-axis and a second absorptive polarizing filter 1164 having its axis of polarization at α degrees clockwise to the x-axis are used to purify the two beams and create a single state of linear polarization in both completely polarized beams 1166.

FIGS. 12A to 18 depict linear polarization converters of light and devices utilizing the principles of methods and devices in accordance with the present embodiment. These devices are meant to be practical exemplary applications of the principles discussed hereinabove. While any desirable state of linear polarization is possible in accordance with the present embodiments, the desirable state of polarization for the devices of FIGS. 12A to 18 is linear polarization which has a horizontal axis of polarization (P-polarized). In addition, the purification stage, which as stated hereinabove, is optional and has been omitted from the devices of FIGS. 12A to 18 as the non-absorptive polarizing filters are assumed to be ideal and light has no exit but through the filters. Those skilled in the art will realize that the possible acceptable designs are not limited to the devices of FIGS. 12A to 18 and are limited only by the principles discussed herein and the parameters and requirements of the resultant product. In addition, the shapes, the angles and the sizes of all elements and devices are flexible. For instance, the non-absorptive polarizing filter could be curved in shaped rather than flat to reflect light like a concave mirror.

Referring to FIGS. 12A, 12B, 12C and 12D, illustrations 1200, 1230, 1250, and 1280 depict linearly polarized light source devices 1202, 1232, 1252, 1282 which emit a robust amount of polarized light out a non-absorptive polarizing filter 1204 which has a horizontal axis of polarization.

Referring to the illustration 1200, the device 1202 includes the non-absorptive polarizing filter 1204 and a light source 1206 emitting unpolarized or randomly polarized light (one exemplary ray of unpolarized light 1208 is depicted) and a rotating filter 1212 within an outer reflective casing 1210. The rotating filter 1212 is a direction independent rotating filter which rotates the axis of undesirably linearly polarized light ideally by the sum of 90°.

The unpolarized ray of light 1208 is divided by the non-absorptive polarizing filter 1204 into a transmitted ray of light 1214 and a reflected ray of light 1216. The transmitted ray of light 1214 is polarized by the non-absorptive polarizing filter 1204 (which has a horizontal axis of polarization) to be P-polarized. The reflected ray of light 1216 has a vertical axis of polarization (S-polarized) and passes through the rotating filter 1212 a first time to become a ray of light 1218 having an axis of polarization oblique to the x-axis. The ray of light 1218 is reflected off the reflective casing 1210 and passes through the rotating filter 1212 a second time to become a ray of light 1220 having a horizontal axis of polarization (as the two passes through the rotating filter 1212 rotate polarization axis of the ray of light ideally by the sum of 90°). The ray of light 1220 passes through the non-absorptive polarizing filter 1204 with polarization unaffected as the axis of polarization of the ray of light 1220 is parallel to the axis of polarization of the polarizing filter 1204, then exits the device 1202 having the same axis of polarization as the transmitted ray of light 1214.

Referring to the illustration 1230, the device 1232 includes the non-absorptive polarizing filter 1204, the light source 1206 and the rotating filter 1212 within the outer reflective casing 1210. The device 1232 differs from the device 1202 in that the positions of the rotating filter 1212 and the light source 1206 are reversed. The rotating filter is direction independent similar to illustration 1200. The unpolarized ray of light 1208 passes through the rotating filter unmodified as it is not polarized. The unpolarized ray of light 1208 is then divided by the non-absorptive polarizing filter 1204 into a transmitted ray of light 1234 and a reflected ray of light 1236. The transmitted ray of light 1234 is polarized by the non-absorptive polarizing filter 1204 (which has a horizontal axis of polarization) to be P-polarized. The reflected ray of light 1236 has a vertical axis of polarization (S-polarized) and passes through the rotating filter 1212 a first time to become a ray of light 1238 having an axis of polarization oblique to the x-axis. The ray of light 1238 is then reflected off the reflective casing 1210 and passes through the rotating filter 1212 a second time to become a ray of light 1240 having a horizontal axis of polarization (as the two passes through the rotating filter 1212 rotate polarization axis of the ray of light ideally by the sum of 90°). The ray of light 1240 passes through the non-absorptive polarizing filter 1204 with polarization unaffected as the axis of polarization of the ray of light 1240 is parallel to the axis of polarization of the polarizing filter 1204, then exits the device 1232 having the same axis of polarization as the transmitted ray of light 1234.

Referring to the illustration 1250, the device 1252 is a trapezoidal shaped device and includes the non-absorptive polarizing filter 1204, the light source 1206 and two rotating filters 1212a, 1212b within the outer reflective casing 1210. The rotating filters 1212a, 1212b are direction dependent rotating filters. The unpolarized ray of light 1208 passes through the rotating filter unmodified as it is unpolarized. The unpolarized ray of light 1208 is then divided by the non-absorptive polarizing filter 1204 into a transmitted ray of light 1254 and a reflected ray of light 1256. The transmitted ray of light 1254 is horizontally polarized by the non-absorptive polarizing filter 1204. The reflected ray of light 1256 has a vertical axis of polarization and passes through the rotating filter 1212b to become a ray of light 1258 having an axis of polarization oblique to the x-axis. The ray of light 1258 is reflected twice off the reflective casing 1210 and passes through the rotating filter 1212a to become a ray of light 1260 having a horizontal axis of polarization (as the two passes through the rotating filter 1212b and the rotating filter 1212a rotate the polarization axis of the ray of light ideally by the sum of 90°). Regarding the configuration of non-absorptive decomposing polarizing filter and the reflective surfaces (i.e. outer reflective casing), the rotating filters 1212a, 1212b must be installed in a manner to rotate polarization axis of the incident linearly polarized beam of light increasingly despite the opposite direction of propagation like the exemplary rays 1256, 1258). The ray of light 1260 passes through the non-absorptive polarizing filter 1204 with polarization unaffected as the axis of polarization of the ray of light 1260 is parallel to the axis of polarization of the polarizing filter 1204 then exits the device 1252 having the same axis of polarization as the transmitted ray of light 1254.

Referring to the illustration 1280, the device 1282 is a trapezoidal shaped device and includes the non-absorptive polarizing filter 1204, the light source 1206 and two rotating filters 1212a, 1212b within the outer reflective casing 1210. The rotating filters 1212a, 1212b are direction dependent rotating filters. The device 1282 differs from the device 1252 in that the positions of the rotating filters 1212a, 1212b and the light source 1206 are reversed. The unpolarized ray of light 1208 is divided by the non-absorptive polarizing filter 1204 into a transmitted ray of light 1284 and a reflected ray of light 1286. The transmitted ray of light 1284 is horizontally polarized by the non-absorptive polarizing filter 1204 (P-polarized). The reflected ray of light 1286 has a vertical axis of polarization (S-polarized) and passes through the rotating filter 1212b to become a ray of light 1288 having an axis of polarization oblique to the x-axis. The ray of light 1288 is then reflected twice off the reflective casing 1210 and passes through the rotating filter 1212a to become a ray of light 1290 having a horizontal axis of polarization (as the two passes through the rotating filter 1212b and the rotating filter 1212a rotate the polarization axis of the ray of light ideally by the sum of 90°). Regarding the configuration of non-absorptive decomposing polarizing filter and the reflective surfaces (i.e. outer reflective casing), the rotating filters 1212a, 1212b must be installed in a manner to rotate polarization axis of the incident linearly polarized beam of light increasingly despite the opposite direction of propagation like the exemplary rays 1286, 1288. The ray of light 1290 passes through the non-absorptive polarizing filter 1204 with polarization unaffected as the axis of polarization of the ray of light 1290 is parallel to the axis of polarization of the polarizing filter 1204, then exits the device 1282 having the same axis of polarization as the transmitted ray of light 1284.

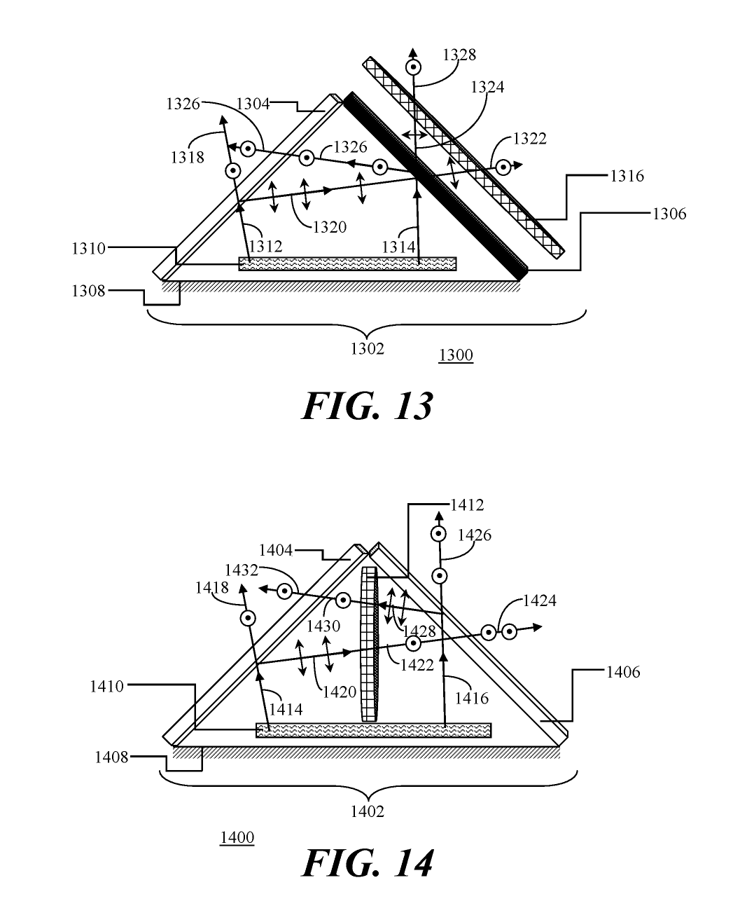

Referring to FIG. 13, an illustration 1300 depicts a triangular shaped device 1302 which includes a non-absorptive polarizing filter 1304 having a horizontal axis of polarization, a non-absorptive polarizing filter 1306 having a vertical axis of polarization and an outer reflective casing 1308 forming the triangular shape and enclosing a light source 1310 placed parallel to the outer reflective casing 1308 and emitting unpolarized or randomly polarized light (two exemplary rays of unpolarized light 1312, 1314 are depicted). The device 1302 also includes a rotating filter 1316 outside and parallel to the polarizing filter 1306, the rotating filter 1316 rotates the axis of undesirably linearly polarized light ideally by 90°.

The unpolarized ray of light 1312 is divided by the non-absorptive polarizing filter 1304 into a transmitted ray of light 1318 and a reflected ray of light 1320. The transmitted ray of light 1318 is linearly polarized by the non-absorptive polarizing filter 1304 (which has a horizontal axis of polarization) to be P-polarized. The reflected ray of light 1320 has a vertical axis of polarization (S-polarized) and passes through the non-absorptive polarizing filter 1306 with polarization unaffected as the axis of polarization of the ray of light 1320 is parallel to the axis of polarization of the polarizing filter 1306. The ray of light 1320 then passes through the rotating filter 1316 to become a ray of light 1322 exiting the device 1302 with a horizontal axis of polarization, the same axis of polarization as the transmitted ray of light 1318.

The unpolarized ray of light 1314 is divided by the non-absorptive polarizing filter 1306 into a transmitted ray of light 1324 and a reflected ray of light 1326. The transmitted ray of light 1324 is polarized by the polarizing filter 1306 (which has a vertical axis of polarization) to be S-polarized. The reflected ray of light 1326 has a horizontal axis of polarization (P-polarized) and passes through the non-absorptive polarizing filter 1304 with polarization unaffected as the axis of polarization of the ray of light 1326 is parallel to the axis of polarization of the polarizing filter 1304.

The ray of light 1324 passes through the rotating filter 1316 to become a ray of light 1328 exiting the device 1302 with a horizontal axis of polarization, the same axis of polarization as the initially reflected ray of light 1326. In this manner, it can be seen that all light exiting the device 1302 has a horizontal axis of polarization.

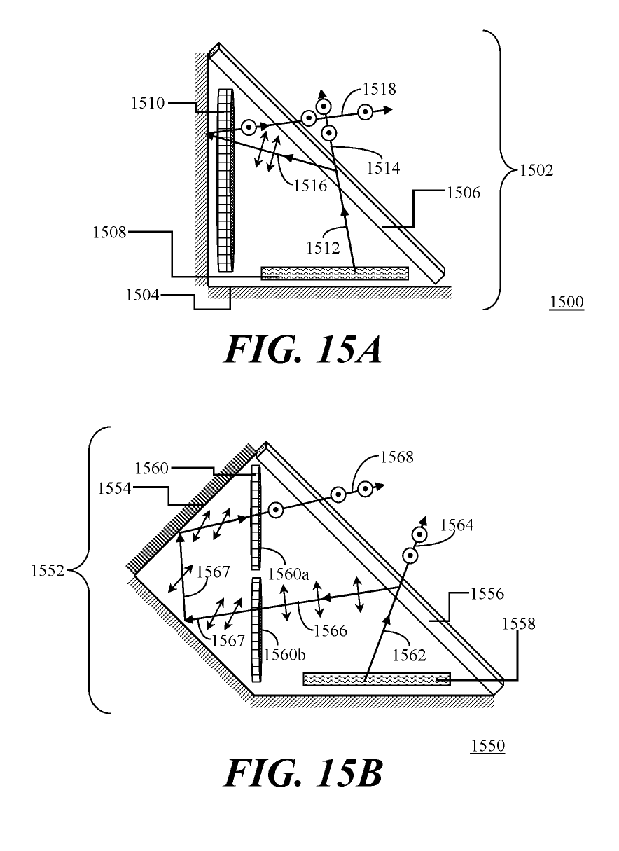

Referring to FIG. 14, an illustration 1400 depicts a second triangular shaped device 1402 which includes a first non-absorptive polarizing filter 1404 having a horizontal axis of polarization, a second non-absorptive polarizing filter 1406 having a horizontal axis of polarization and an outer reflective casing 1408 forming the triangular shape and enclosing a light source 1410 placed parallel to the outer reflective casing 1408 and a rotating filter 1412. The light source 1410 emits unpolarized or randomly polarized light (two exemplary rays of unpolarized light 1414, 1416 are depicted) and the rotating filter 1412 is placed on top of a center portion of and perpendicular to the light source 1410. The rotating filter 1412 rotates the axis of undesirably linearly polarized light ideally by 90°.

The unpolarized ray of light 1414 is divided by the non-absorptive polarizing filter 1404 into a transmitted ray of light 1418 and a reflected ray of light 1420. The transmitted ray of light 1418 is polarized by the non-absorptive polarizing filter 1404 (which has a horizontal axis of polarization) to be P-polarized. The reflected ray of light 1420 has a vertical axis of polarization (S-polarized) and passes through the rotating filter 1412 which rotates the axis of polarization such that the rotated ray of light 1422 has a horizontal axis of polarization. The ray of light 1422 passes through the non-absorptive polarizing filter 1406 with polarization unaffected as the axis of polarization of the ray of light 1422 is parallel to the axis of polarization of the polarizing filter 1406 to become a ray of light 1424 exiting the device with a horizontal axis of polarization, the same axis of polarization as the transmitted ray of light 1418.

The unpolarized ray of light 1416 is divided by the non-absorptive polarizing filter 1406 into a transmitted ray of light 1426 and a reflected ray of light 1428. The transmitted ray of light 1426 is linearly polarized by the non-absorptive polarizing filter 1406 (which has a horizontal axis of polarization) to be P-polarized. The reflected ray of light 1428 has a vertical axis of polarization (S-polarized) and passes through the rotating filter 1412 and its axis of polarization is rotated to become a ray of light 1430 having a horizontal axis of polarization. The ray of light 1430 passes through the non-absorptive polarizing filter 1404 with polarization unaffected as the axis of polarization of the ray of light 1430 is parallel to the axis of polarization of the polarizing filter 1404, exiting the device with a horizontal axis of polarization, the same axis of polarization as the transmitted ray of light 1426. In this manner, it can be seen that all light exiting the device 1402 has a horizontal axis of polarization.

Referring to FIGS. 15A and 15B, two illustrations 1500, 1550 depict additional devices 1502 and 1552. Referring to the illustration 1500, the device 1502 is a triangular device formed on two sides by a reflective outer casing 1504 and, on the third side by a non-absorptive polarizing filter 1506 which has a horizontal axis of polarization. A light source 1508 and a direction independent rotating filter 1510 are placed inside the triangle perpendicular to each other and each parallel to separate ones of the two sides formed by the reflective outer casing 1504. The light source 1508 emits unpolarized or randomly polarized light (one exemplary ray of unpolarized light 1512 is depicted) within the triangular device 1502. The rotating filter 1510 which is a direction independent rotating filter rotates the polarization axis of undesirably linearly polarized light by 90°.

The unpolarized ray of light 1512 is divided by the non-absorptive polarizing filter 1506 into a transmitted ray of light 1514 and a reflected ray of light 1516. The transmitted ray of light 1514 is polarized by the non-absorptive polarizing filter 1506 (which has a horizontal axis of polarization) to be P-polarized. The reflected ray of light 1516 has a vertical axis of polarization (S-polarized) and passes through the rotating filter 1510 a first time, is reflected off the reflective casing 1504 and passes through the rotating filter 1510 a second time to become a ray of light 1518 having a horizontal axis of polarization (as the two passes through the rotating filter 1510 rotate polarization axis of the ray of light ideally by the sum of 90°). The ray of light 1518 passes through the non-absorptive polarizing filter 1506 with polarization unaffected as the axis of polarization of the ray of light 1518 is parallel to the axis of polarization of the polarizing filter 1506, then exits the device 1502 having a horizontal axis of polarization, the same axis of polarization as the transmitted ray of light 1514.

Referring to the illustration 1550, the device 1552 is an irregular quadrangular device formed on three sides by a reflective outer casing 1554 and, on the fourth side by a non-absorptive polarizing filter 1556 which has a horizontal axis of polarization. A light source 1558 and a pair of direction dependent rotating filters, comprising a pair 1560 of rotating filters 1560a and 1560b, are placed inside the device 1552 perpendicular to each other and forming a triangle with the side of the quadrangle formed by the polarizing filter 1556. The light source 1558 emits unpolarized or randomly polarized light (one exemplary ray of unpolarized light 1562 is depicted) within the quadrangular device 1552. The rotating filters 1560a, 1560b rotate the polarization axis of undesirably linearly polarized light by the sum of 90°. Regarding the configuration of non-absorptive decomposing polarizing filter and the reflective surfaces (i.e. outer reflective casing), the rotating filters 1560a, 1560b must be installed in a manner to rotate the polarization axis of the incident linearly polarized beam of light increasingly despite the opposite direction of propagation like the exemplary rays 1566, 1567.

The unpolarized ray of light 1562 is divided by the non-absorptive polarizing filter 1556 into a transmitted ray of light 1564 and a reflected ray of light 1566. The transmitted ray of light 1564 is polarized by the non-absorptive polarizing filter 1556 (which has a horizontal axis of polarization) to be P-polarized. The reflected ray of light 1566 has a vertical axis of polarization (S-polarized) and passes through the rotating filter 1560b to become a ray of light 1567 having an axis of polarization oblique to the x-axis. the ray of light 1567 is reflected twice off the reflective casing 1554 and passes through the rotating filter 1560a to become a ray of light 1568 having a horizontal axis of polarization (as the two passes through the rotating filters 1560b, 1560a rotates the polarization axis of the ray of light ideally by the sum of 90°).

The ray of light 1568 passes through the non-absorptive polarizing filter 1556 with polarization unaffected as the axis of polarization of the ray of light 1568 is parallel to the axis of polarization of the polarizing filter 1556 then exits the device 1552 having a horizontal axis of polarization, the same axis of polarization as the transmitted ray of light 1564.

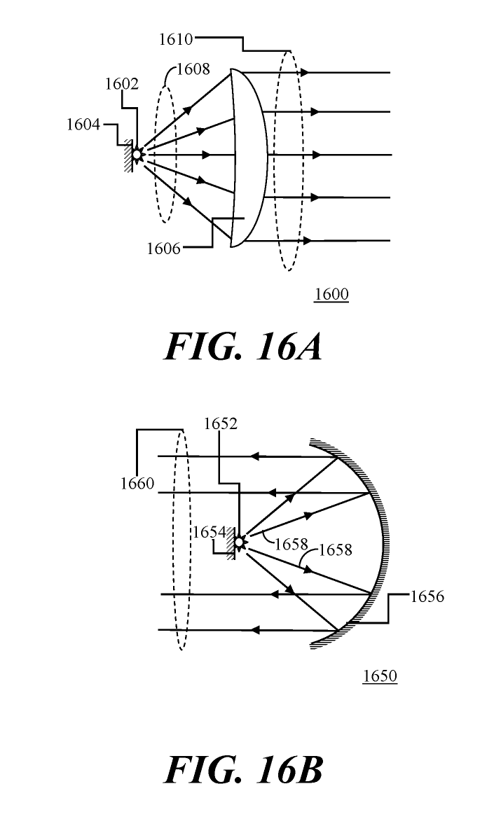

Referring to FIGS. 16A and 16B, illustrations 1600, 1650 depict devices which can be used in accordance with present embodiments to render incident beams of light parallel as some non-absorptive polarizing filters (such as dielectric mirrors and other photorefractive devices which use the Fresnel equation as their principle of operation) or some rotating filters are sensitive to the angle of incidence of light. Referring to the illustration 1600, a light source 1602 placed between a rear reflecting casing 1604 and an optical lens 1606 emits unpolarized light. The light source 1602 emits unpolarized or randomly polarized divergent rays of light (exemplary rays of unpolarized light 1608 are depicted) and those striking first side of the optical lens 1606 pass through the lens 1606 and exit the other side of the lens 1606 as a bundle of parallel rays of light 1610. The light source 1602 is placed at the focal point of the optical lens 1606.

Referring to the illustration 1650, a light source 1652 placed between a rear reflecting casing 1654 and a concave mirror 1656 emits unpolarized light. Exemplary rays of unpolarized light 1658 striking the concave mirror 1656 are reflected as a bundle of parallel rays of light 1660 if the light source 1652 is placed at the focal point of the concave mirror 1656.

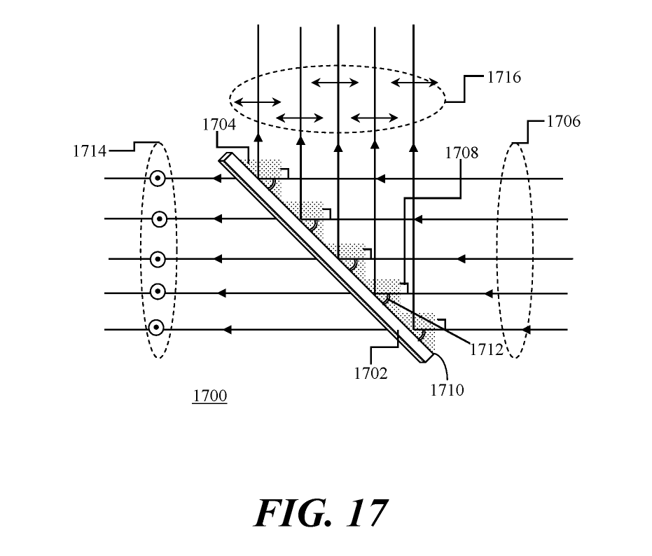

Referring to FIG. 17, an illustration 1700 depicts a method to avoid unwanted optical effects of a boundary between air and a first layer of a dielectric mirror such that parallel rays of light bypass the boundary between the first layer of dielectric and air, thus they could strike directly at the first internal boundary between alternating layers of the dielectric mirror at the internal boundary's Brewster's angle. A Bragg mirror 1702 has a saw-toothed index matching material 1704 (which has the same refractive index as the first layer of dielectric on which it is mounted) on one side. Parallel rays of unpolarized incident light 1706 pass through the index matching material 1704 at a right angle 1708 to a vertical aspect of the saw-toothed index matching material 1704 and strikes a first internal boundary 1710 of the Bragg mirror 1702 at its Brewster's angle 1712. The first internal boundary 1710 of the Bragg mirror 1702 is a boundary between the low refractory index layer of the mirror and a high refractory index layer of the Bragg mirror 1702. Parallel rays transmitted 1714 through the Bragg mirror 1702 have a horizontal axis of polarization. Parallel rays reflected 1716 from the Bragg mirror 1702 from the incident rays 1706 have a vertical axis of polarization.

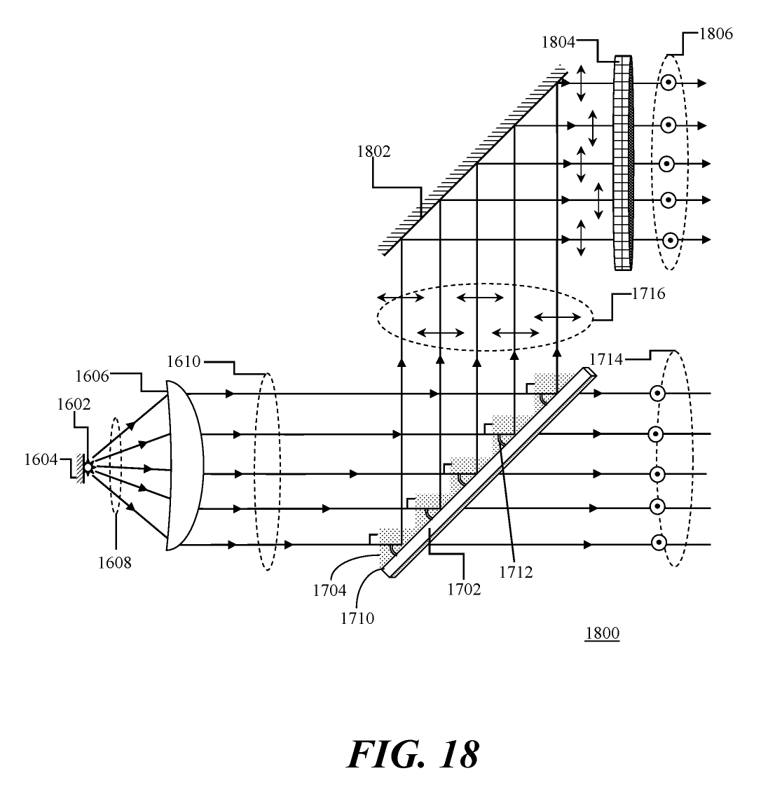

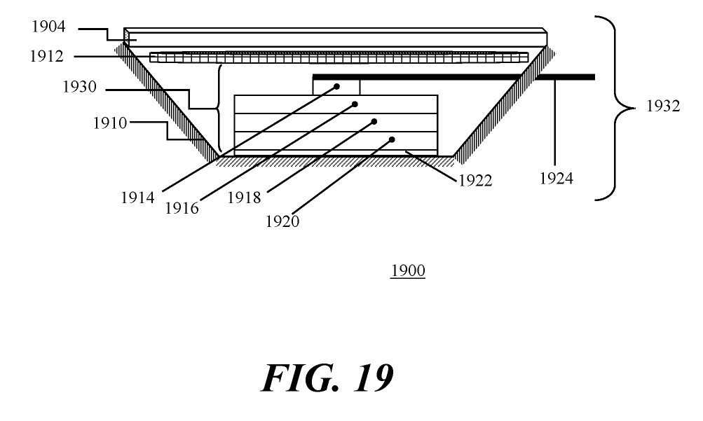

Referring to FIG. 18, an illustration 1800 depicts a device using the optical lens 1606 (FIG. 16A) and the Bragg mirror 1702 (FIG. 17) in accordance with the present embodiment. The light source 1602 is placed at the focal point of the optical lens 1606 between the rear reflecting casing 1604 and the optical lens 1606. Unpolarized light beams 1608 emitted from the light source 1602 strike first side of the optical lens 1606, pass through the lens 1606, and exit it as parallel rays of light 1610. The parallel rays of unpolarized light 1610 passes through the index matching material 1704 at a right angle to a vertical aspect thereof and strikes the first internal boundary 1710 of the Bragg mirror 1702 at its Brewster's angle 1712. Parallel rays transmitted 1714 through the Bragg mirror 1702 have a horizontal axis of polarization. Parallel rays reflected 1716 from the Bragg mirror 1702 from the incident rays 1610 have a vertical axis of polarization.

A reflective casing (mirror) 1802 reflects the parallel rays 1716 having the vertical axis of polarization which then passes through a rotating filter 1804 to become parallel rays of light 1806 having a horizontal axis of polarization (as the rotating filter 1804 rotates the polarization axis of the ray of light 90°), the rays of light 1806 exiting the device having the same axis of polarization and direction as the transmitted rays of light 1714.

Referring to the FIG. 19, an illustration 1900 depicts an exemplary device using the design depicted in FIG. 12B (illustration 1230) in combination with a simplified LED technology. The device includes a non-absorptive polarizing filter 1904, an unpolarized light source 1930 and a rotating filter 1912 within an outer reflective casing 1910. The unpolarized light source 1930 is a simplified light emitting diode (LED) and only includes the elements essential for its operation. These essential elements from bottom to top include: an electrode 1922, a n type semiconductor 1920, a p-n junction 1918, a p type semiconductor 1916 and a p electrode 1914. The n electrode 1922 is electrically connected to the cathode through the outer reflective casing 1910 which is also known as an anvil or, alternatively the n electrode 1922 could be connected directly to the cathode. The p electrode 1914 is electrically connected to an anode (post) through an electrically insulated wire 1924. The rotating filter 1912 rotates the polarization axis of undesirably polarized rays of light ideally by the sum of 90°.

Thus, it can be seen that the present embodiments provide light polarization converters and devices using such linear polarization converters of light which overcome the drawbacks of the prior art systems and provides highly efficient, robust linear polarization of received optical energy. Present embodiments nearly double the optical efficiency of devices using the novel linear polarization converters of light such as LED displays, LC displays, polarized light microscopes, camera flashes and other display and illumination devices. In accordance with present embodiments, the need for light sources in devices which use polarized light can be reduced by a maximum of 50% in terms of wattage or number, resulting in significant reduction in production costs both in material and manufacture. The reduction in the number of light sources or the wattage required by such illumination or display devices significantly decreases the energy consumption thereby, increasing electrical efficiency of stationary or mobile compatible devices and increasing the battery life of mobile devices.

Two-thirds of the energy consumption of a conventional television set is consumed by backlight of the transmissive display panel (LCD panel). In a 4K-high resolution TV set, the energy demand for backlighting increases up to 30%. This increase is due to intense backlighting for display of greater details of images 122 (FIG. 1) in terms of resolution, brightness and color. Utilizing methods and devices in accordance with present embodiments for illumination and backlighting of the transmissive display panels significantly decreases the energy demand of backlights and also the total energy demand of such display devices which in return will allow decreasing the capacity of all electrical devices supplying electrical energy for the device and the backlighting panel. These devices include power adapters, power control systems and even the wiring. The power adapter is a device which decreases the input voltage and increases the output electrical current to a desired operational level. The power control system controls distribution of electrical energy between the different electrical parts of the display device (i.e. the TV set), including the backlight. The power control system switches on or off the electrical parts or regulates their electrical current. All other devices using principles of transmissive display panels to operate can benefit from using the methods and devices in accordance with the present embodiments in a similar way. Examples of these devices include LED TV sets, LCD TV sets, video projectors, computer displays, laptops, notebooks, tablets, cellphones, smart watches and mp3/mp4 players.

Accordingly, by increasing throughput of polarized light and reducing the absorption or wasting of optical energy in illumination and backlight illumination of display devices, present embodiments provide an environmentally-friendly, energy saving solution that could potentially reduce electrical consumption in the United States of America by up to 7% in commercial and residential sectors, which in turn could reduce more than 10% of CO₂ emissions of these sectors related to electricity.

Devices structured and operating in accordance with present embodiments include all display devices which use the principles of LCD panels (FIG. 1) to operate from LED and LCD big screen televisions and video projectors all the way down to computer displays, laptops, tablets, smart phones, mp3/mp4 players and smart watches. The energy savings result in reduced cost of operation (electricity consumption), extended battery life for the mobile devices and reduced CO₂ emissions and carbon footprints, and the piece part and manufacturing step savings result in reduced cost of production, reduced size and/or weight of the devices and increased capacity for production of backlighting systems without significant new capital investments.

Devices structured and operating in accordance with present embodiments also include illumination devices such as camera flashes and similar technologies. For illumination devices, utilization of present embodiments provide energy savings, reduced cost of production and operation and reduced weight and size, as well as significant reduction of reflection of light from the surface of transparent materials such as water and glass, and even reflection from the surface of human skin and eyes to provide a deep uniform illumination.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

What is claimed is:

1. A method for linear polarization of light comprising:
generating optical energy of unpolarized light;
transforming the unpolarized light into linearly polarized light; and
transmitting at least some of the linearly polarized light as transmitted light, the transmitted light having a desirable axis of polarization, wherein the transforming step comprises:
decomposing the unpolarized light into a transmitted beam of light and a reflected beam of light, wherein at least one of the transmitted beam of light and the reflected beam of light has an undesirable axis of polarization; and
rotating a polarization axis of the light beam having the undesirable axis of polarization to the desirable axis of polarization for transmitting as at least some of the transmitted light.

2. The method in accordance with claim 1 further comprising, after the transforming step, the step of purifying the transformed light into completely linearly polarized light before transmitting it as the transmitted light.

3. The method in accordance with claim 1 further comprising after the decomposing step recycling any of light having the undesirable axis of polarization back to the generation step.

4. The method in accordance with claim 1 wherein the decomposing step comprises non-absorptive linear polarization at predetermined axes of polarization to generate the transmitted beam and the reflected beam of linearly polarized light from incident unpolarized light wherein the predetermined axes of polarization of the transmitted beam and the reflected beam are mutually perpendicular to each other and at least one of the transmitted beam and the reflected beam has an undesirable axis of linear polarization.

5. The method in accordance with claim 1 wherein the rotating step comprises rotating the polarization axis of the light beam having the undesirable axis of polarization a predetermined amount and direction of rotation to rotate the polarization axis of the light beam having the undesirable axis of polarization to the desirable axis of polarization.

6. The method in accordance with claim 2 wherein the purifying step comprises purifying the transformed light of any unwanted polarization components to make them completely linearly polarized at the desirable axis of linear polarization.

7. An illumination device, for providing linearly polarized light having a desirable axis of polarization, the illumination device comprising:
a light source for generating unpolarized beams of light;
a non-absorptive decomposing polarizing filter having a predetermined axis of polarization for decomposing the unpolarized beams of light incident thereon into a transmitted beam of light and a reflected beam of light, wherein at least one of the transmitted beam of light and the reflected beam of light has an undesirable axis of polarization; and
one or more rotating filters for rotating the polarization axis of the incident linearly polarized light beam having the undesirable axis of polarization to the desirable axis of polarization for transmitting as at least some of the provided linearly polarized light.

8. The illumination device in accordance with claim 7 wherein the non-absorptive decomposing polarizing filter comprises a non-absorptive linear polarizer having a predetermined axis of polarization for decomposing the unpolarized light and generating the transmitted beam and the reflected beam of linearly polarized light from the incident unpolarized light wherein the polarization axes of the transmitted beam and the reflected beam are mutually perpendicular to each other and wherein at least one of the transmitted beam and the reflected beam has an undesirable axis of linear polarization.

9. The illumination device in accordance with claim 7 wherein the one or more rotating filters are configured to provide a predetermined amount and direction of rotation of a polarization axis of incident linearly polarized light for rotating the polarization axis of the light having the undesirable axis of polarization to the desirable axis of polarization.

10. The illumination device in accordance with claim 7 further comprises a transforming step wherein transformation of light comprises:
decomposing the unpolarized light into a transmitted beam of light and a reflected beam of light, wherein at least one of the transmitted beam of light and the reflected beam of light has an undesirable axis of polarization; and
rotating a polarization axis of the light beam having the undesirable axis of polarization to the desirable axis of polarization for transmitting as at least some of the provided linearly polarized light.

11. The illumination device in accordance with claim 7 further comprising one or more purifying linear polarizers having a predetermined axis of polarization for purifying transformed linearly polarized beams of light from any unwanted polarization component to make them completely linearly polarized at a desirable axis of linear polarization, and wherein the one or more purifying linear polarizers are absorptive polarizing filters, non-absorptive polarizing filters or a combination of absorptive polarizing filters and non-absorptive polarizing filters.

12. The illumination device in accordance with claim 7 further comprising one or more reflective surfaces for light containment formed on at least a portion of a housing of the illumination device.

13. The illumination device in accordance with claim 7 wherein the illumination device comprises a general purpose light source for illuminating one or more desired objects, the desired objects and corresponding light source selected from the group comprising subjects of photography and a corresponding camera flash devices, the subjects of filming and corresponding lighting equipment, transmissive display panels and a corresponding backlight, subjects of microscopic study and a corresponding light source in a polarized light microscopy device, and underwater objects in the night and a corresponding underwater illumination device.

14. A display device comprising:
a transmissive display panel; and
a backlight for generating linearly polarized beams of light,
wherein the backlight acts as an illumination light source for the transmissive display panel and generates linearly polarized beams of light for utilization by the transmissive display panel to generate user viewable output thereon, and wherein the backlight comprises:
a light source for generating unpolarized beams of light;
a non-absorptive decomposing polarizing filter having a predetermined axis of polarization for decomposing the unpolarized beams of light incident thereon into a transmitted beam of light and a reflected beam of light, wherein at least one of the transmitted beam of light and the reflected beam of light has an undesirable axis of polarization; and
one or more rotating filters for rotating the polarization axis of the incident linearly polarized light beam having the undesirable axis of polarization to the desirable axis of polarization for transmitting as at least some of the generated linearly polarized beams of light, and
wherein the transmissive display panel includes a first polarizing filter, a transmissive liquid crystal display panel and a second polarizing filter, wherein the polarization axis of the first polarizing filter of the transmissive display panel is parallel to the main polarization axis of the linearly polarized beams of light generated by the backlight.

15. The display device in accordance with claim 14 wherein the non-absorptive decomposing polarizing filter of the backlight comprises a non-absorptive linear polarizer having a predetermined axis of polarization for decomposing the unpolarized light and generating the transmitted beam and the reflected beam of linearly polarized light from the incident unpolarized light, and wherein the polarization axes of the transmitted beam and the reflected beam are mutually perpendicular to each other, and wherein at least one of the transmitted beam and the reflected beam has an undesirable axis of linear polarization.

16. The display device in accordance with claim 14 wherein the one or more rotating filters of the backlight are configured to provide a predetermined amount and direction of rotation of a polarization axis of incident linearly polarized light for rotating the polarization axis of the light having the undesirable axis of polarization to the desirable axis of polarization.

17. The display device in accordance with claim 14 wherein the backlight further comprises one or more purifying linear polarizers having a predetermined axis of polarization for purifying transformed linearly polarized beams of light from any unwanted polarization component to make them completely linearly polarized at a desirable axis of linear polarization, and wherein the one or more purifying linear polarizers are absorptive polarizing filters, non-absorptive polarizing filters or a combination of absorptive polarizing filters and non-absorptive polarizing filters.

18. The display device in accordance with claim 14 wherein the transmissive display panel further comprises:
a first polarizing filter;
a transmissive liquid crystal display panel; and
a second polarizing filter,
wherein the first polarizing filter is disposed between the backlight and the transmissive liquid crystal display panel for receiving linearly polarized light from the linearly polarized beams of backlight to provide completely linearly polarized light for illumination of the transmissive liquid crystal display panel, and wherein the second polarizing filter is configured to act as an analyzer to generate a viewable image from light transmitted through the transmissive liquid crystal display panel.

19. The display device in accordance with claim 18 wherein the first polarizing filter of the transmissive display panel is an absorptive linearly polarizing filter, a non-absorptive linearly polarizing filter or a combination of an absorptive polarizing filter and a non-absorptive polarizing filter.
